(19) United States
(12) Patent Application Publication
(10) Pub. No.: US 2015/0159427 A1
(43) Pub. Date: Jun. 11, 2015

(54) ANTI-INTRUSION SLIDING DOOR

(71) Applicant: GILGEN DOOR SYSTEMS AG, Schwarzenburg (CH)

(72) Inventors: Beat Dutsch, Kehrsatz (CH); Liridon Kaba, Liebefeld (CH)

(73) Assignee: GILGEN DOOR SYSTEMS AG, Schwarzenburg (CH)

(21) Appl. No.: 14/407,368

(22) PCT Filed: Jun. 6, 2013
(86) PCT No.: PCT/EP2013/061671

§ 371 Date: Dec. 11, 2014

(30) Foreign Application Priority Data
Jun. 21, 2012 (CH) 00876/12

(51) Int. Cl. E06B 5/11; E05B 65/08; E05C 19/00; E05D 15/06

(52) U.S. Cl. CPC E06B 5/113; E05D 15/0621; E05B 65/08; E05C 19/00

(57) ABSTRACT

A sliding wing system having a sliding wing that can be moved in a floor guide so as to close a building opening and provides a first vertical closing edge. The sliding wing system provides a second vertical closing edge, the first and the second vertical closing edges can be brought into a closing arrangement. A dimensionally stable groove, which extends in the vertical direction and consists of metal or plastic, is arranged on at least one closing edge at least in some sections. A dimensionally stable comb, which corresponds to the groove, extends substantially in the vertical direction and protrudes, and consists of metal or plastic, is arranged opposite each groove. The groove and the comb can be brought into engagement in a formfitting manner, the engagement extending in sections over at least half of the longitudinal extension of the vertical closing edges.

### TECHNICAL FIELD

The present invention relates to a sliding wing system according to the preamble of claim 1 and to a closing edge construction therefor.

### PRIOR ART

Sliding wing systems, in particular sliding door systems, are widely used, preferably at locations where building openings are frequently passed through by people. A sliding wing system is capable of rapidly and reliably operating a large building opening through which one or more people can pass at the same time. It is a fundamental requirement that said sliding wing systems also prevent unauthorized entry, i.e., for example, are lockable overnight. The main closing edge of said systems constitutes a weak point in the closing system for safety against intrusion.

WO 2010 034 081 A1 discloses a lock with an engagement element, which is mounted movably along the main closing edge, on a sliding wing. When the door is closed, said engagement element is movable from a release position into a locking position, wherein said engagement element can be brought into engagement with a counterpart, which projects into the movement of the engagement element, on the other sliding wing and can then be fixed, and therefore the sliding door is closed. However, such a construction is disadvantageous since relatively large openings and/or elements protruding in the closing direction have to be provided in the closing edges of the sliding doors for engagement of engagement element and counterpart. In addition, a complicated construction reliably providing the linear movement of the engagement element over several centimeters has to be provided for the actuation of the closing mechanism.

Sealing elements for sealing the main closing edge in sliding door systems are known, for example, from DE 102 12 09 B4, DE 10 2006 062 332 A1 and EP 1 431 501 B1. Said sealing elements seal the closing edge in particular in respect of gas exchange, but do not increase the security of the door system against unauthorized entry.

U.S. Pat. No. 3,774,342 discloses a sliding door in which a groove/ridge-like construction engages in each other on a vertical closing edge and a closing mechanism is provided in this region.

### SUMMARY OF THE INVENTION

It is therefore an object of the present invention to provide a sliding wing system, in particular a sliding door system or sliding window system or a closing edge construction, which provides increased mechanical stability for better protection against intrusion.

This object and further objects are achieved by a sliding wing system, in particular an automatic sliding door system, comprising at least one sliding wing, wherein the sliding wing is displaceable in a floor guide device along a closing movement so as to close a building opening in a pass-through direction and provides a first vertical closing edge in a substantially horizontal closing direction, and the sliding wing system provides a second vertical closing edge, wherein the first and the second vertical closing edge can be brought into closing contact with each other, and wherein the sliding wing provides a horizontal closing edge which, together with the floor guide device, forms a horizontal secondary closing edge extending along the closing direction, in that at least one dimensionally stable outer flank which extends substantially in the vertical direction, protrudes freely in the closing direction and is composed of metal or plastic or a combination thereof, which is attached on the corresponding vertical closing edges in a manner offset toward an outer side of the building opening, is provided at least in sections on at least one of said vertical closing edges, in that a dimensionally stable ridge which corresponds to said outer flank, extends substantially in the vertical direction and protrudes in the closing direction and is composed of metal or plastic or a combination thereof is arranged on the other vertical closing edge, in each case opposite said outer flank, wherein said ridge runs with respect to the outer flank in a manner offset laterally toward an inner side of the building opening and, by means of the closing movement, can be brought into engagement (by a form-fitting connection in the pass-through direction) with an inner side of the flank, which inner side is directed toward the inner side of the building opening, and in that a closing device which is arranged on said vertical closing edges and has at least one locking point for fixing the sliding wing when the first and second vertical closing edges are in closing contact with each other is provided, wherein said locking point is provided on the ridge side, and therefore the outer flank covers the locking point toward the outer side of the building opening.

The outer flank together with the vertical closing edge, to which said flank is attached, forms a first step or a first offset, wherein the ridge together with the other vertical closing edge forms a second step or a second offset. The first step and the second step are of mirror-inverted design here such that they can intermesh in the closing direction. The first and the second step can also be of multi-stepped configuration. The outer flank here engages over the ridge at least partially, preferably substantially entirely, and therefore the ridge is covered toward the outer side of the building opening by the outer flank. A free end of the ridge is therefore not accessible from the outer side when the vertical closing edges are in closing contact.

A development of the sliding wing system is characterized in that a further, inner flank which runs substantially parallel to the outer flank and is attached in a manner offset at a distance in the pass-through direction from the outer flank toward the inner side of the building opening is provided on the vertical closing edge providing the outer flank. This inner flank also protrudes toward the ridge, wherein the inner flank is substantially mirror-symmetrical to the outer flank with respect to a mirror plane, wherein said mirror plane is a vertical plane through the wing center and parallel to the building opening.

A substantially vertically running groove is formed between the outer flank and the inner flank, said groove being open in the closing direction and being bounded in a direction parallel to the pass-through direction by the outer and the inner flank. The flanks preferably protrude here over the vertical closing edge substantially by the same amount in the closing direction. The groove formed here and said ridge are configured here in such a manner that they can be brought into mutual engagement by the closing movement. It is preferred that said engagement, taken together in sections, extends over at least half of the longitudinal extent of the vertical closing edges, preferably over the entire longitudinal extent of the vertical closing edges. Furthermore, it is preferred that said ridge extends in the pass-through direction substantially over the clear width of the groove and in the vertical direction substantially over a length of the groove. In an advantageous manner, upon engagement in the groove, the ridge engages in the groove substantially as far as to a depth of the groove. Thus, in particular, the outer flank of the ridge is supported and can readily withstand pressure perpendicularly on the flank (from the outside).

It is preferred that the flank(s) protrudes or protrude over the vertical closing edge in the closing direction freely by 10 millimeters to 30 millimeters and has or have here a material thickness in the pass-through direction, said material thickness preferably tapering toward a free end of the flank(s) and in each case being at least 2 millimeters to 10 millimeters, preferably more than 3 millimeters, in particular 4 millimeters or more. The ridge can then be, for example, 20 to 90 millimeters in width at its free end in the pass-through direction.

The flank here should therefore be understood as meaning a ridge-like projection which covers the ridge toward the inner side (inner flank) or outer side (outer flank) of the building opening. The vertical closing edges are brought together in the closing direction on the ridge and in the depth behind the flank on that side of the flank which faces the ridge (i.e. in the vicinity of the extension of the flank on the vertical closing edge, and away from the free end of said flank) and are lockable there to protect the flank against access from the outer side.

The tongue and groove system therefore solidly prevents the accessibility by means of a burglary tool to the locking points, for example to pivoting bolts.

It is furthermore preferred that the ridge is attached to the corresponding vertical closing edge in a manner offset toward the inner side of the building opening, and therefore, when the vertical closing edges are in closing contact, the outer flank which is provided so as to be able to cover the ridge toward the outer side of the building opening engages over the ridge in the closing direction to such an extent toward the vertical closing edge providing the ridge that a vertically running gap between the free end of the outer flank and the vertical closing edge providing the ridge has a clear width in the closing direction of less than 2 millimeters, in particular of less than essentially 1 millimeter. Preferably, in a region about said vertical gap running along the main closing edge formed by the vertical closing edges, a substantially aligned surface is formed toward the outer side of the building opening. This makes it difficult to insert a lever tool (or impact tool) for the purpose of prying open the flank and increases the security of the system against intrusion. Such an engagement of the flank over the ridge is intended to be provided in particular from the attack side (the outer side of the building opening), but may also be implemented on the inner side of the system.

The flanks are preferably flanks which are spaced apart with respect to each other in the pass-through direction by preferably at least 10 millimeters or more, in particular by 20 to 90 millimeters, and which preferably run substantially continuously along the vertical closing edge. Said flanks here are preferably attached to end regions, which lie opposite each other in the pass-through direction, of the corresponding vertical closing edge, i.e. in the vicinity of the vertical edges of the sliding wing.

The groove formed by the inner and outer flanks here preferably has a depth in a direction parallel to the closing direction of at least 10 millimeters to 30 millimeters or more, wherein a clear width in the pass-through direction is at least 10 millimeters or more, in particular 20 to 90 millimeters.

The abovementioned and further objects are also achieved by a sliding wing system, comprising at least one sliding wing, wherein the sliding wing is displaceable in a floor guide device along a closing movement so as to close a building opening in a pass-through direction and provides a first vertical closing edge in a substantially horizontal closing direction, and the sliding wing system provides a second vertical closing edge, wherein the first and the second vertical closing edge can be brought into closing contact with each other, and wherein the sliding wing provides a horizontal closing edge which, together with the floor guide device, forms a horizontal secondary closing edge extending along the closing direction, in that at least one dimensionally stable groove which substantially extends in the vertical direction, is open in the closing direction, and is composed of metal or plastic or a combination thereof is arranged at least in sections an at least one of said vertical closing edges, and a dimensionally stable ridge which corresponds with said groove, extends substantially in the vertical direction and protrudes in the closing direction and is composed of metal or plastic or a combination thereof is arranged on the other vertical closing edge, in each case opposite said groove, wherein said groove and said ridge can be brought into engagement in a form-fitting manner by the closing movement, wherein said engagement, taken together in sections, extends over at least half of the longitudinal extent of the vertical closing edges, and in that, furthermore, a closing device which is arranged on said vertical closing edges and is intended for fixing the sliding wing when the first and second vertical closing edges are in closing contact with each other is provided.

The expression “taken together in sections” means that all of the vertical sections of the vertical closing edge that provide such an engagement upon mutual contact, when totaled in their length over the vertical extent, produce at least half of the length of the longitudinal extent of a vertical closing edge. In other words, the vertical closing edge intermesh over at least half of their vertical extent via a tongue and groove connection.

The groove is configured as a channel-shaped depression, with a depth of preferably at least essentially 10 millimeters, in particular from essentially 11.5 millimeters up to 30 millimeters. The ridge, a projection running along the main closing edge, is functionally configured as a tongue and is suitable for forming a tongue and groove connection with the groove. It is expedient here to allow the ridge to grip as far as to the depth of the groove (i.e. to the rear boundary thereof) so that sufficient mechanical stability is produced in the closing position. It is therefore clear that it is preferable if the ridge projects in the direction of the groove to approximately the same amount as the depth of the groove. Said corresponding elements (groove and elevation) are therefore preferably substantially formed as geometrical counterparts.

The expression “dimensionally stable” means that the intermeshing elements—groove and ridge—remain in engagement in a dimensionally stable manner even under the action of a force, in particular from the pass-through direction (and are also correspondingly inherently stable), and counter said action of force. Typical forces would be, for example, if action is taken against the door; such a force can be, for example, 100N to 6000N or more. In order to withstand such forces, the ridge and the groove are formed so as to correspond in dimensions (see below) such that forces which are directed against a weak point of the closing system, namely against groove and/or ridge, for example in the event of an intrusion attempt, can be absorbed. In addition, sensitive elements of the closing device are intended to be concealed in said groove and/or the ridge and the adjacent profiles and to be accommodated in a manner difficult to access. If the system is in the closed position, flanks which form the groove surround the ridge laterally over at least 8 to 15 millimeters and preferably come into contact with the side surfaces of the ridge in the pass-through direction. The flanks are preferably laterally supported by the ridge if the inherent stability of said flanks does not suffice in the event of an action of force from a direction at an angle to the closing direction. Access into the groove is therefore effectively blocked and the closing device is accessible at least in this region only by the flanks being broken open. Therefore, the flanks which act in a concealing manner are intended to be formed so as also to be sufficiently thick and made from a strong material that unauthorized entry (in particular to the locking mechanism) is effectively countered.

In order to prevent the sliding wings from being slid open (along the closing movement), the stable closing device is provided, said closing device securing the engagement of the ridge in the groove and preferably being at least partially surrounded by groove and/or ridge and therefore likewise being protected from unauthorized access.

It is preferred if the groove has a depth of at least 10 millimeters or more in a direction parallel to the closing direction and has a clear width in the pass-through direction of at least 10 millimeters or more. The groove can be formed here by flanks which are attached to the corresponding vertical closing edge, preferably protrude in the closing direction by 10 millimeters to 30 millimeters and are spaced apart with respect to each other in the pass-through direction by preferably at least 10 millimeters or more, in particular by essentially 25 millimeters, and preferably run substantially continuously along the vertical closing edge. Said flanks can preferably be attached to end regions, which lie opposite each other in the pass-through direction, of the corresponding vertical closing edge, preferably in a manner aligned from the outside with the sliding wing, wherein the flanks are in each case free-standing in the closing direction and the respective thickness or material thickness of said flanks is 1 millimeter to 10 millimeters, preferably more than 3 millimeters, in particular 4 millimeters or more, in the pass-through direction and, preferably, said material thickness tapers by 10% to 50% in the closing direction (i.e. toward the free end of the flank). If the flanks are thus considered in a cross-sectional view (sectional plane formed by pass-through direction and closing direction), the flanks taper in the closing direction toward their respective free end. It is particularly preferred if the vertical profiles which are in closing contact form an aligned surface on the inner side and the outer side of the wing (i.e. perpendicularly to the pass-through direction). This then means that the flanks preferably taper on the groove side (i.e., that is to say internally; in other words: on the ridge side when the system is closed) in material thickness in the pass-through direction. The groove, i.e. the corresponding recess, is therefore then of substantially trapezoidal cross-sectional design at least in sections.

The locking of the sliding wing/sliding wings then takes place in the depth of the groove, and therefore the locking mechanism is protected by the mentioned flanks of the groove.

It is furthermore advantageous in this connection if the flanks of the groove fit snuggly against the ridge in such a manner that the vertical gap on the main closing edge is reduced to a minimum of approximately 1 millimeter or less. This prevents or makes difficult the fitting of lever tools, for example a crowbar, for the purpose of prying open the flanks of the groove. The gap mentioned is intended to be minimal in particular on the sliding wing side toward the outer side of the building, the attack side.

In order to ensure this, it is preferred not to allow the sides of the ridge, in a cross-sectional view, to run as far as the vertically running edges of the corresponding vertical profile. An offset is therefore produced in the pass-through direction, in which the flanks of the groove can engage. In addition, this makes it possible for the flanks of the groove to continue to be sufficiently thick in the pass-through direction (3 to 4 millimeters or more) at their free ends despite a possible tapering so that said flanks cannot be easily bent upward or broken open.

The ridge can be attached to the other vertical closing edge lying opposite said groove, wherein said ridge extends substantially over the clear width of the groove in the pass-through direction and substantially over a length of the groove in the vertical direction and, upon engagement in the groove, engages substantially as far as to a depth of the groove, i.e. the ridge projects, for example, by 8 millimeters or more, depending on the design of the groove.

It is preferred that the closing device provides at least one engagement recess, which is continuously open in the closing direction toward the outside, on one of said vertical closing edges, preferably in the ridge or in the depth of the groove. The closing device here can have at least one bolt which is attached to the other vertical closing edge and is preferably arranged in the depth of the groove or in the ridge and which, when the vertical closing edges bear against each other in a closing manner for locking the sliding wing, is rotatable, pivotable and/or displaceable into said engagement recess for the form-fitting engagement with respect to a direction parallel to the closing direction, wherein said engagement recess and the corresponding bolt form a locking point.

It is preferred that the vertical closing edges provide at least two vertically spaced-apart locking points which form a pair and which are each protected in the locked state by the flank from access on the flank side. The force produced by the use of the burglary tool therefore always acts on at least two locking points because of the construction. The load per individual locking point is therefore theoretically halved, but in any case reduced.

A distance between said two locking points is preferably 50 millimeters to 250 millimeters or less, in particular essentially 150 millimeters, wherein, preferably, two or more such pairs of locking points are arranged distributed over the vertical closing edges. It is particularly preferred to provide a pair of locking points above the center of the main closing edge and a further such pair below said center.

The closing device can provide, for example, at least one closing strip which is attached in the ridge and preferably runs vertically and which at least partially, preferably completely, surrounds the engagement recess. The closing device can provide at least one pivoting bolt case, which is attached in the depth of the groove, with a pivoting bolt which is mounted along a pivoting movement and, when the vertical closing edges bear against each other, so as to be pivotable from the pivoting bolt case into the respective engagement recess into a locking position, wherein the pivoting bolt preferably engages behind the closing strip in the locking position. The form-fitting connection is therefore provided in a direction parallel to the closing direction.

In order to optimize the tightness of the pivoting bolt, an entry slope can be provided in each case on the closing strip. The pivoting bolt then interlocks in the closing strip, and therefore the system is locked. In this connection, for example, known pivoting bolt closing parts can be used in an alternating or identical orientation. The pivoting bolt closure is advantageously provided with a means of securing against counterpressure.

The pivoting bolt is preferably formed from steel or from another material known to a person skilled in the art, wherein the bolt has a material thickness of at least 3 to 8 millimeters or more. Material choice and dimensioning depend on each other in a manner known to a person skilled in the art. Depending on the intended purpose, hardened or non-hardened bolts can be used. Additional centering pins protruding in the closing direction can be provided on the groove and/or ridge and a corresponding recess can be provided on the ridge and/or groove opposite each pin in order to guide the engagement between groove and ridge and to strengthen the system in the closing position.

In a development of the invention, a form-fitting connection is intended to be provided on the secondary closing edge in order further to improve the stability of the system (especially in the closed position) and the operability of said system. For this purpose, at least one floor bolt with an engagement element can be provided on the horizontal secondary closing edge of the at least one displaceable sliding wing, wherein the engagement element preferably protrudes downward by 5 millimeters to 50 millimeters from the horizontal secondary closing edge and preferably extends over 50 millimeters to 200 millimeters along the closing direction. Said floor bolt is preferably also manufactured from steel (preferably hardened, but can also be non-hardened material). Furthermore, the floor guide device can provide, along the closing movement, a floor guide profile with a guide chamber which is open upward, is bounded in the pass-through direction by a guide chamber wall and corresponds with the floor bolt, wherein, preferably, a floor connecting profile which is embedded in the floor (for example set in concrete) and is intended for receiving the floor guide profile is provided. Floor connecting profile and floor guide profile can be made from metal and fixed in relation to each other (for example by screwing). The engagement element of the floor bolt is movable displaceably along the closing movement in a manner projecting substantially over its protrusion height (in the vertical direction) in the guide chamber and guiding the displaceable sliding wing, wherein the floor bolt preferably makes contact with the guide chamber wall via a sliding element (for example made from plastic) in order to prevent a metal/metal rubbing contact. Said sliding element can also act in a noise-reducing manner and/or can improve the frictional properties of the system.

The engagement element is therefore guided along the closing movement (which includes both directions) in the guide chamber, in a manner identical to a sliding block in a groove, and therefore a form-fitting connection is provided in the pass-through direction, which increases the mechanical stability. The sliding wing system can in particular comprise at least one first sliding wing and one second, opposed sliding wing for closing the building opening, which sliding wings are displaceable in the floor guide device along the closing movement and parallel to the closing direction in a manner releasing or closing the building opening. This travel path therefore determines the closing movement. In this connection, the first sliding wing in the closing direction (with respect to the first wing) provides the first vertical closing edge and the second sliding wing in the closing direction (with respect to the second wing) provides the second vertical closing edge.

It is preferred that the first vertical closing edge is provided by a first vertical profile and the second vertical closing edge is provided by a second vertical profile, wherein said vertical profiles are preferably formed from metal or plastic or a combination of said materials. The vertical profiles are also intended to be provided to be correspondingly dimensionally stable and therefore unbreakable.

The vertical profiles are preferably formed identically in the rear region and are differentiated by the provision of the groove or the ridge. The vertical profiles preferably extend by 40 millimeters to 200 millimeters, preferably essentially 100 millimeters, in the closing direction and by 20 millimeters to 100 millimeters, preferably 35 millimeters, in the pass-through direction and preferably substantially over an entire height of the the building opening (for example 2.2 to 3.5 meters). One of the first and second vertical profiles provides the at least one groove, preferably extending along the entire vertical closing edge, and the other vertical profile provides the ridge corresponding with said groove, preferably extending substantially along the whole of the groove. The groove/the ridge can therefore be provided on the first or second vertical closing edge or in sections on the first vertical closing edge and in a different section on the second vertical closing edge. It is also possible in principle for two grooves or two ridges or for one groove and one ridge to be provided parallel to a vertical closing edge, wherein the vertical closing edge arranged opposite is then configured in a complementary manner so that the desired form-fitting engagement is possible. The groove can be configured, as seen in a cross section from the vertical direction (horizontal section), so as to be substantially rectangular or trapezoidal at least in sections or preferably over the entire depth and so as to widen in the closing direction. Said widening of the groove in the closing direction advantageously acts on the ridge in a receiving and centering manner, also as defined by the centering pins.

It is preferred that the first and the second vertical profile intermesh along the first and second vertical closing edges and parallel to the closing direction in a manner forming a substantially aligned surface. When in contact with each other (in the closed position), the first and second vertical profiles therefore form an aligned surface. This permits a slender construction and acts in an esthetically advantageous manner.

The floor bolts mentioned are preferably attached to the two lower corners of the sliding wing such that the sliding wing is guided and secured at the rear and front. The floor bolts have an L shape. By introduction of the L-shaped floor bolts into the frame of the sliding wing, the corner regions are additionally reinforced, which further increases the security against intrusion.

It is therefore preferred that the at least one displaceable sliding wing provides a vertical terminating profile on its end section opposite the vertical closing edge, wherein the horizontal closing edge is in each case formed by lower ends of the vertical profile and of the vertical terminating profile and preferably by a horizontal profile connecting said lower ends of the vertical profile. The vertical profile, the vertical terminating profile and the horizontal profile then form the frame of the sliding wing (at least laterally and at the bottom). In this connection, one of said floor bolts can be provided in each case on the horizontal closing edge, on the end side in a direction parallel to the closing direction (i.e. in the lower corner regions).

It is furthermore preferred that the floor bolts are each substantially L-shaped and each have a first limb preferably protruding by 40 millimeters to 200 millimeters horizontally over the engagement element and in each case a second limb preferably protruding by 40 millimeters to 150 millimeters vertically upward over the engagement element. The engagement element therefore forms the L shape with said limbs. In this context, the floor bolts can in each case be fastened by the first limb to the horizontal closing edge, wherein the respective vertical profile and the vertical terminating profile of a sliding wing at their lower ends in each case provide vertical chambers which are open downward and run in the vertical direction and into which the respective second limb of the floor bolts can in each case preferably be completely pushed and can be fixed there.

A preferred development is characterized in that a lock plate which extends in the vertical direction, and is fixed in a form-fitting manner in the vertical profile at least with respect to a direction parallel to the closing direction, limits the groove in depth, in that a vertical chamber extending rearward into the sliding wing is provided on an inner side of said lock plate, said inner side facing away from the vertical closing edge, and in that the at least one pivoting bolt case with a pivoting bolt is fastened so as to project from said inner side of the lock plate into a depth of the vertical chamber counter to the closing direction. In this connection, the pivoting bolt is pivotable in a pivoting movement out of the pivoting bolt case through a recess in the lock plate into the groove and, when the vertical closing edges are in closing contact, into the engagement recess and is preferably fixable in said pivoted-out state.

A lock plate with a U-shaped cross section is preferred. The free ends of the U lock plate preferably protrude here to the rear toward the vertical chamber, wherein the free ends are preferably received in the vertical profile in a form-fitting manner with respect to the pass-through direction via corresponding slots in the vertical profile. The U lock plate therefore engages on both sides in the vertical profile over the depth of the groove (and therefore the groove is limited in depth by the lock plate) and therefore stabilizes the flanks which are provided by the vertical profile and bound the groove in the pass-through direction. The flanks are, as it were, held together, which additionally secures the groove/ridge engagement and counters a forcible breaking open of the groove from the outside (for example with the aid of a lever tool).

In addition, it is conceivable that the pivoting bolt case is fastened at the rear in the depth of the vertical chamber by means of a further form-fitting connection with respect to a direction parallel to the closing direction, preferably via at least one mushroom-headed pin which is attached to the pivoting bolt case and protrudes rearward into the depth of the vertical chamber and which is fixable in a form-fitting manner in recesses in a holding strip which is attached in a form-fitting manner with respect to the direction parallel to the closing direction in the depth of the vertical chamber.

A driving rod is advantageously provided, by means of which the closing device is actuable (lockable or unlockable) manually or automatically, wherein a central lock is provided for the manual actuation. The driving rod here can be designed so as to engage in the pivoting bolt case in order there, in the pivoting case, to guide the pivoting bolt located therein over a pivoting movement, wherein the pivoting bolt can be brought from a starting position (in which it is preferably completely retracted into the case) via the pivoting movement into the locking position. The driving rod preferably runs in the lock plate, preferably from the inner side thereof in the vertical profile, as a result of which the driving rod is difficult to access. The linear movement of the driving rod is then converted into the pivoting movement of the pivoting bolts.

In the locking position, the pivoting bolt can protrude through the U lock plate toward the closing strip and can engage through the ridge or into the ridge into recesses of the closing strip and can lock the main closing edge in a form-fitting manner with respect to the closing movement.

Furthermore, it is preferred that at least two pivoting bolt cases are each provided with at least one pivoting bolt. It is advantageous in this connection to provide at least two said pivoting bolts close to each other. Close here means spaced apart vertically from each other by 20 millimeters to 300 millimeters. By means of this directly adjacent arrangement, the forces which act on the lock and therefore in particular also on the pivoting bolts, for example, in the event of an intrusion attempt, are in each case distributed substantially uniformly to the at least two adjacently arranged pivoting bolts and therefore to at least two locking points. This increases the security of the arrangement against intrusion.

In a particularly preferred embodiment, at least two pairs of preferably vertically spaced-apart pivoting bolt cases are provided, wherein a lower pair of pivoting bolt cases is attached below the central lock and/or the motor, and an upper pair of pivoting bolt cases is attached above the central lock and/or the motor. In this connection, the pivoting bolts are provided preferably following different pivoting movements in pairs, wherein the pivoting movements are differentiated in particular in that the pivoting bolt is either pivotable from the bottom upward or from the top downward into the respective engagement recess of the closing strip.

It is preferred here that the pivoting bolts of the upper pair of pivoting bolt cases are both provided so as to be pivotable from the bottom upward or, alternatively, are both provided so as to be pivotable from the top downward, wherein the pivoting bolts of the lower pair of pivoting bolt cases are then both provided so as to be pivotable in an opposed manner to the upper pair of pivoting bolts, namely from the top downward or both are provided so as to be pivotable from the bottom upward. The pivoting bolts of the upper pair of pivoting bolt cases and the pivoting bolts of the lower pair of pivoting bolt cases are therefore pivotable in a substantially opposite direction with respect to the main closing edge (i.e. in an opposed manner). The two pairs of pivoting bolt cases then lock in a form-fitting manner with respect to a direction parallel to the main closing edge, and the locked sliding wing cannot be displaced vertically, and therefore it is not possible to disengage the pivoting bolt hooks which engage behind the closing strip. Such a configuration therefore prevents the hook-like pivoting bolts which engage behind the engagement recess from being simply disengaged.

A sealing profile, for example a central sealing rubber, is preferably attached to the main closing edge, said sealing profile sealing the flanks, which engage around the ridge and form the groove, toward the elevation, and therefore the closure between groove and elevation is sealed.

A closing edge construction for a sliding wing system, as depicted above, can achieve the object of the present invention in that the groove is formed by flanks which are attached to one of the vertical closing edges, preferably provide a vertical profile, preferably protrude by 5 millimeters to 20 millimeters in the closing direction and are spaced apart from one another in the pass-through direction and preferably run substantially continuously along the vertical closing edge, wherein said flanks are preferably attached to end regions of the vertical closing edge, which end regions are opposite each other in the pass-through direction, wherein the flanks are each free-standing in the closing direction and the respective material thickness thereof in the pass-through direction is in each case at least 1 millimeter to 10 millimeters, preferably more than 3 millimeters, in particular of 4 or 5 millimeters or more, and wherein, preferably, said material thickness tapers by 10% to 50% in the closing direction.

In a development, the above-described sliding wing system can comprise an anti-prying-open means which is provided above the at least one sliding wing. At least when a building opening is closed, said anti-prying-open means can limit raising of said sliding wing substantially in the vertical direction and/or pivoting of said sliding wing in the pass-through direction, in particular for the purpose of disengaging a floor bolt, in particular the abovementioned floor bolt, in each case by the anti-prying-open means striking against an element arranged lying opposite the anti-prying-open means, wherein said opposite element in particular comprises parts of a running profile or of a running carriage for moving said sliding wing. It is preferred in this connection that, if the anti-prying-open means strikes upward due to a prying-open attempt and therefore interrupts the lifting movement, the anti-prying-open means (for example a metal plate) makes extensive contact with the opposite element (for example the running profile). Said extensive contact is then preferably such that a displacement of the sliding wing along the closing movement from the closed state into the open state of the building opening is made difficult because of friction or is prevented by a form-fitting connection. For this purpose, the abovementioned extensive contact can take place via rough, but at any rate not smooth, contact surfaces, wherein the friction between the contact surfaces, which are pressed against each other and interrupt the lifting movement, then makes it difficult to displace the sliding wing for the purpose of opening the sliding system. As an alternative or in addition, the elements or surfaces entering into contact can have, for example, a corresponding toothing. Individual ridges of the toothing can then run in the pass-through direction, and therefore the anti-prying-open means and the element lying opposite thereto can be brought into engagement in such a manner that the abovementioned displacement of the raised sliding wing is made impossible.

It is furthermore conceivable that the above-described sliding wings are guided at the top in guide rails via a running carriage, preferably two or more running carriages. Said guide rails are preferably provided here by a running profile which is fixed in a stationary manner, for example, to a wall, but at any rate securely above the sliding wings. The sliding wings then extend into the running profile via the running carriages, wherein the running carriages in each case provide running wheels by means of which the running carriages are movable in the running profile. The running wheels here preferably have concave or convex running surfaces. The running carriages can then be placed by said running wheels, which are preferably arranged in a row, into the correspondingly complementarily shaped guide rail, come into engagement with the rail and are mounted movably together with the sliding door. By means of the abovementioned complementary configuration of wheel and rail, the running carriage is also pivotable over a limited angular range of, for example, 5 to 15 degrees without the construction being damaged due to the transverse forces in effect. However, this pivoting movement may also lead to security problems; for example, due to willful pivoting into a limit region, access from the outside to the inner construction is possible or the sliding wing can even be disengaged.

Means can therefore be provided which close said security gap. A sliding wing system with at least one displaceable sliding wing can thus be provided, wherein a running profile is provided above the sliding wing, wherein the sliding wing engages upward into the running profile over at least one, preferably two running carriages, wherein the running carriage is hooked into the running profile and is movable by means of running wheels on a guide rail provided by the running profile, wherein the running carriage provides at least one, preferably two, anti-prying-open means.

A first anti-prying-open means can be a contact element which protrudes upward from the running carriage and is dimensionally stable, for example a metal plate, wherein said contact element is arranged preferably in a manner offset horizontally from the running wheel with respect to a vertical direction and limit a lifting movement of the running carriage or of the wing upward by coming into contact with a preferably stationary element (which is preferably provided by or on the running profile) which acts as a stop. When the running carriage is pivoted in a direction parallel to the pass-through direction, said first anti-prying-open means or a second anti-prying-open means, which can also be of plate-like design, can serve as a contact element for a further stop in the pivoting direction. The further stop here is preferably again a stationary element which is provided by or on the running profile. Said stops are intended to be provided in particular whenever the sliding wing is in the closed position. Further embodiments are indicated in the dependent claims.

### BRIEF DESCRIPTION OF THE DRAWINGS

Preferred embodiments of the invention are described below with reference to the drawings which serve merely for explanation and should not be interpreted as being restrictive. In the drawings:

FIG. 1 shows a schematic sliding door system according to an exemplary embodiment of the present invention;

FIG. 2 shows a floor guide device from the side according to an exemplary embodiment of the invention;

FIG. 3 shows a perspective view of a sliding wing from below with a vertical profile (on the right), a horizontal profile (at the bottom) and a vertical terminating profile (on the left) and with a further vertical profile, adjoining the right, of a second sliding wing according to an exemplary embodiment of the invention;

FIG. 4 shows an exploded illustration of the sliding wing according to FIG. 3 in a perspective view from the bottom on the right;

FIG. 5 shows a perspective illustration of the sliding wing according to FIG. 3 from the bottom on the right with parts of a closing device (lock plate with motor and pivoting bolt cases with retaining plate) according to an exemplary embodiment of the invention, but without the vertical profile of the second closing wing, in which the abovementioned parts of the closing device are accommodated;

FIG. 6 shows the subject matter according to FIG. 5, wherein the vertical profile of the sliding wing according to FIG. 3 has been omitted;

FIG. 7 shows a view of the subject matter according to FIG. 6 from the left, wherein, furthermore, the horizontal profile has been omitted;

FIG. 8 shows an enlarged perspective view from the top on the right of a lock plate with pivoting bolt cases with a retaining plate according to FIG. 5, wherein said parts are shown in the vertical profile, and wherein the vertical profile has been cut open;

FIG. 9 shows the subject matter according to FIG. 8, wherein the vertical profile has been cut open further above and wherein the corresponding vertical profile according to FIG. 3 adjoins on the left;

FIG. 10 shows the lock plate according to FIG. 8 without a motor, but in an expanded overall view with an upper and a lower pair of pivoting bolt cases according to FIG. 5;

FIG. 11 shows a central lock for a sliding door according to FIG. 1 in a perspective view from the rear;

FIG. 12 shows the central lock according to FIG. 11 in a perspective view from the front;

FIG. 13 shows the main closing edge of the sliding door according to FIG. 3 with details regarding the vertical profiles and the inserted elements in a view from above;

FIG. 14 shows the subject matter according to FIG. 13 in the same view, but without vertical profiles;

FIG. 15 shows a perspective view from obliquely on the left at the bottom of a running rail with running carriages which guide the sliding wing according to FIG. 3 at the top;

FIG. 16 shows a detail of the subject matter according to FIG. 15 from the front on the left; and

FIG. 17 shows a side view of the subject matter according to FIG. 15.

### DESCRIPTION OF PREFERRED EMBODIMENTS

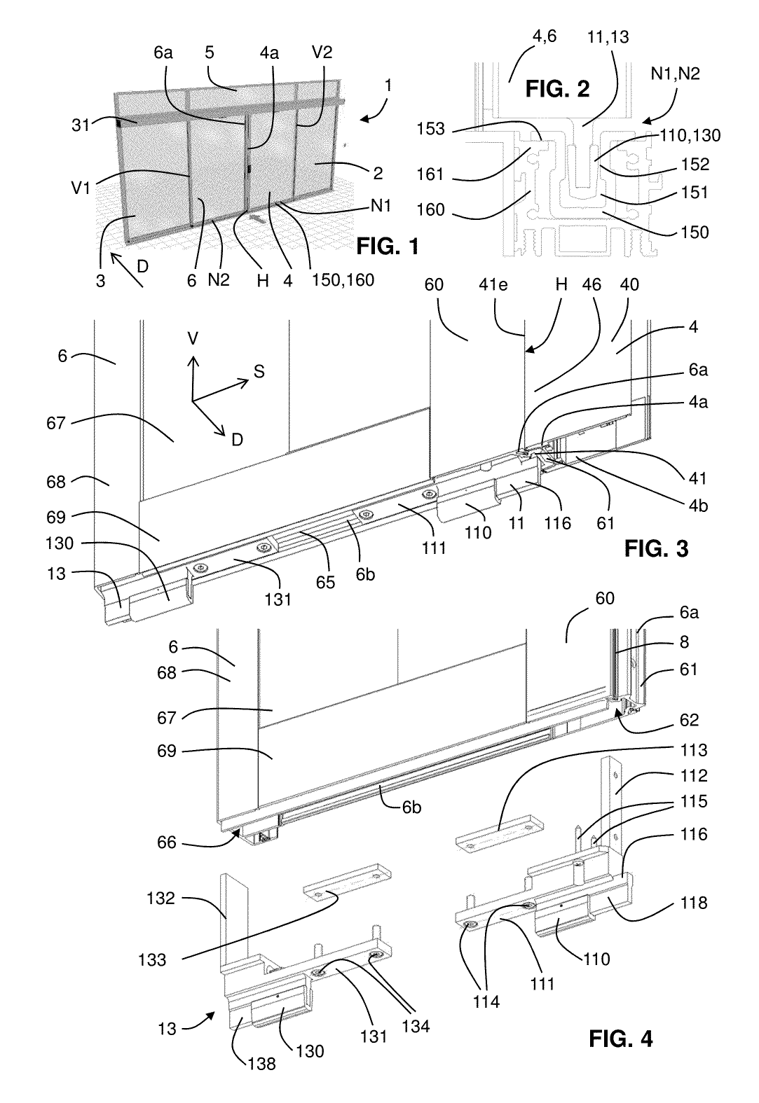

FIG. 1 shows a sliding door system 1 with two sliding wings 4, 6, two side parts 2, 3 and an upper light 5 extending over the entire width of the sliding door system 1. Side parts 2, 3 and upper light 5 can in principle be omitted; in addition, only an individual sliding wing 4, 6 can be provided. The embodiment as illustrated in the figures will now be described here. The two sliding wings 4, 6 each have, in the closing direction, a vertical closing edge 4a, 6a and, downward, a horizontal closing edge 4b, 6b. The vertical closing edges 4a, 6a from a main closing edge H in contact with each other in the closed position. The closing direction S for the sliding wing 4, which is illustrated on the right in FIG. 1, runs horizontally from the right to the left. The closing direction S for the sliding wing 6, which is illustrated on the left in FIG. 1, runs horizontally from the left to the right.

It is therefore noted that, in the present text, unless understood otherwise from the context, the closing direction should be understood as always being related to the respective sliding wing.

The two sliding wings 4, 6 together with their respective lower horizontal closing edges 4b, 6b and a floor guide device 150, 160 in each case form a horizontal secondary closing edge N1, N2. The vertical secondary closing edges 4b, 6b are formed on the vertical edges of the respective sliding wings 4, 6, which edges in each case lie opposite the abovementioned vertical closing edges 4a, 6a. The elements assigned to the first sliding wing 4 (on the right in FIG. 1) are in each case identified, where necessary, by the term “first”, and the elements assigned to the second sliding wing 6 (on the left in FIG. 1) are in each case identified by the term “second”.

FIG. 2 shows a cut-open floor guide unit 150, 160. For the sake of clarity, the hatching has been omitted in this sectional illustration. The floor guide unit 150, 160 is recessed or embedded in a stationary and fixed manner in the floor, and, as a result, increased stability and, consequently, improved security against intrusion are provided. In FIG. 2, the lower end section of the sliding wing 4, 6 is apparent in the upper region. A floor bolt 11, 13 protrudes downward from said lower end section of the sliding wing 4, 6. A sliding element 110, 130 is pulled over the floor bolt 11, 13 and is preferably fastened there. The floor bolt 11, 13 with slider 110, 130 projects into a guide chamber 151 (see FIG. 2). The guide chamber 151 is formed by a floor guide profile 150 of the floor guide unit 150, 160. The floor guide profile 150 provides the guide chamber wall 152. As is apparent from FIG. 2, the floor bolt 11, 13 makes contact with the guide chamber wall 152 via the slider 110, 130. The floor bolt 11, 13 together with slider 110, 130 projects here by 30 millimeters into the guide chamber 151 which has a depth of 40 millimeters. The sliding wing 4, 6 is thereby guided in the guide chamber 151 along the closing movement in the closing direction S. The closing direction S is perpendicular to the plane of the drawing in FIG. 2.

The floor guide profile 150 is embedded in a floor connecting profile 160. The floor guide profile 150 is, for its part, embedded in the floor and provides the support surfaces 153 on which support elements 161 of the floor connecting profile 160 rest. The floor guide profile 150 and the floor connecting profile 160 can be fastened here, for example screwed, to each other and in the floor. Furthermore, FIG. 2 shows the first and the second horizontal secondary closing edge N1, N2. FIG. 3 shows, in a perspective view from below, the second sliding wing 6 with parts of the first sliding wing 4. Of the first sliding wing 4, only a vertical profile 40 is illustrated. Said vertical profile 40 provides the first vertical closing edge 4a with a groove 41. A second vertical profile 60 of the second sliding wing 6 provides the second vertical closing edge 6a with a ridge 61. Both the ridge-like elevation 61 and the groove 41 run along the respective vertical profiles 40, 60 over the entire longitudinal extent of the vertical profiles 40, 60.

It is apparent in FIG. 3 how the vertical profiles 40, 60 intermesh according to the tongue and groove principle. The ridge 61 extends here as far as to a depth of the groove 41. By means of this engagement, the vertical closing edges 4a, 6a come into bearing and closing contact with each other and form the vertical main closing edge H. A form-fitting connection between the first vertical profile 40 and the second vertical profile 60 is formed in a pass-through direction D by said tongue and groove engagement. Furthermore, the first and the second vertical profile 40, 60 intermesh in such a manner that the surfaces thereof which are directed in the pass-through direction D form an aligned surface 46 both in the direction of the longitudinal extent of the vertical closing edges 4a, 6a or of the main closing edge H and in the direction of the closing direction S. This permits a slim construction, minimizes the projections and therefore the number of mechanical attack points, which makes the construction more secure and more esthetic.

In addition, a door filling 67, for example made of glass, of the second sliding wing 6 can be seen on the left in FIG. 3. A vertical terminating profile 68 is provided at the left end of the second sliding wing 6 in a manner arranged opposite the second vertical profile 60. The vertical terminating profile 68 and the second vertical profile 60 are connected via a horizontal profile 69. The first sliding wing 4 also has a vertical terminating profile and a horizontal profile, which are not illustrated in FIG. 3, in a similar manner.

The vertical profiles 40, 60 are preferably composed of metal or plastic or of a combination of said materials or of other dimensionally stable materials known to a person skilled in the art, and therefore are extremely dimensionally stable and burglary-resistant, and extend from the floor as far as the lower end of the upper light 5. The walls of the vertical profiles 40, 60 have a thickness of 2 to 5 millimeters. In the closing direction S, the vertical profiles 40, 60 have a width of essentially 100 millimeters, wherein said vertical profiles have a material thickness in the pass-through direction D of 25 to 100 millimeters, in particular of 35 millimeters. The horizontal profile 69 and the vertical terminating profile 68 have the same material thickness in the pass-through direction D. The height of the horizontal profile 69 is 50-120 millimeters, and the longitudinal extent thereof in the closing direction S is up to 200 centimeters. The vertical terminating profile 68 likewise extends from the floor as far as the lower end of the upper light 5 and has a width of essentially 100 millimeters in the closing direction S.

The second horizontal closing edge 6b is now explained. The second horizontal closing edge 6b is provided by the lower ends of the vertical profile 60, of the vertical terminating profile 68 and of the horizontal profile 69. A recess 65 is arranged on the second horizontal closing edge 6b (which is in principle formed in a mirror-inverted manner to the horizontal closing edge 4b with respects to the main closing edge H). Furthermore, the floor bolts 11, 13 which engage in the recess 65 and in the vertical profile 60 and the vertical terminating profile 68 (see below and in FIG. 4) can be seen in FIG. 3. In the completed state of the sliding door system 1, the first vertical profile 40 and the vertical terminating profile assigned thereto each also have a floor bolt, said floor bolts not being illustrated in FIG. 3 for the purpose of clarity; what is stated below for the floor bolts 11, 13 of the second sliding wing 6 also applies correspondingly to the floor bolts of the first sliding wing 4.

With respect to the main closing edge H, the floor bolt in the first vertical profile 40 is formed and attached in a substantially mirror-symmetrical manner to the floor bolt 11 in the second vertical profile 60. The two floor bolts in the vertical profiles 40, 60 are then directed toward each other with respective projections 116. Said projections complete the construction below the main closing edge H in the closing direction S. Furthermore, respective first horizontal limbs 111, 131 and second vertical limbs 112, 132 of the floor bolts 11, 13, which are therefore L-shaped, are illustrated in FIG. 3. Said first limbs 111 and 131 are inserted into the recess 65 in a fitting manner and serve for fastening the floor bolts 11, 13 in the sliding wing 6.

The construction of the floor bolts 11, 13 is now described more precisely with reference to FIG. 4. FIG. 4 shows an exploded illustration of the second sliding wing 6 with floor bolts 11, 13. The second vertical profile 60 with a vertical chamber 62 running vertically upward is illustrated. In addition, the vertical terminating profile 68 with a further, vertically running chamber 66 is shown on the left side.

A first floor bolt 11 is illustrated on the right in the lower region of FIG. 4. The L-shaped floor bolt 11 has an engagement element 118 with a sliding element 110. The engagement element 118 with slider 110 introduced into the guide chamber 151 of the floor guide profile 151 (see FIG. 2). The first limb 111 of the floor bolt 11 runs horizontally beyond the engagement element 118 and is conceived for installing the floor bolt 11 in the recess 65. The second limb 112 of the floor bolt 11 runs in the vertical direction V and can be introduced in a laterally precisely fitting manner into the vertical chamber 62 of the vertical profile 60. The two limbs 111, 112 extend approximately by the same amount over the engagement element 118 as the length of the latter. Furthermore, the floor bolt 11 has screws 115 by means of which the floor bolt 11 which is introduced into the sliding wing 6 can be securely fixed in the vertical profile 60. The engagement element 118 extends in the closing direction S in a length of approximately the width of the vertical profile 60 over the engagement element 118. The engagement element 118 is guided as far as under the ridge 61 via the projection 116 (a section of the engagement element 118). Floor bolts which are arranged opposite each other via the main closing edge H close the gap below the main closing edge H by means of said projections 116. In order to install the floor bolt 11 in the recess 65, the screws 114 by means of which the plate 113 is fastened to the floor bolt 11 are provided on the first limb 111. Said plate 113 is then introduced the depth of the groove 65 and ensures that a floor bolt 11 is securely held vertically in a suitable position.

The second floor bolt 13 which is of substantially mirror-symmetrical configuration to the first floor bolt 11 is illustrated at the bottom on the left in FIG. 4. Said floor bolt 13, like the floor bolt 11, therefore also has an L shape with an engagement element 138, with a first limb 131 which runs horizontally over the engagement element 138, and with a second limb 132 which protrudes vertically over the engagement element 138. A plate 133 is fastened to the first limb 131 via screws 134. Like the plate 113, the plate 133 is placed in the depth of the groove-like recess 65. The second, vertically standing limb 132 can be introduced into the vertically running chamber 66 of the vertical connecting profile 68 and can be fixed there.

The limbs 112 and 132 each have a length of 50 millimeters to 200 millimeters, a width, for example, of 10 millimeters (in the closing direction S) and a thickness of, for example, 30 millimeters to 40 millimeters (in the pass-through direction D), wherein said thickness depends on the corresponding thickness of the vertical profiles 40, 60. By means of this solid construction, the limbs 112 and 132 are introduced deeply into the vertical profiles 40, 60 and the corresponding vertical terminating profiles 68. By means of this configuration, the frame 68, 69, 60 of the sliding wing 4, 6 is stabilized and the guiding of the sliding wing 4, 6 in the floor guide profile 150 is ensured by means of the engagement elements 118, 138. In addition, it is efficiently prevented that the sliding wing 4, 6 is pushed or pulled transversely with respect to the running direction thereof out of the intended position.

Furthermore, the second vertical closing edge 6a of the vertical profile 60 is illustrated at the top on the right in FIG. 4. The ridge 61 which extends in the vertical direction V can readily be seen. Said elevation 61 is introduced as a tongue according to the tongue and groove principle into the groove 41 of the vertical profile 40 and constitutes, as it were, a counter sealing profile with respect to the groove 41. In order to fix the first vertical profile 40 and the second vertical profile 60 in relation to each other, a closing device 20 is provided. The closing device 20 consists of a U lock plate 22 which is placed or pushed into the groove 41 of the vertical profile 40 and which provides (with outer side 222) the rear boundary in the depth of the groove 41.

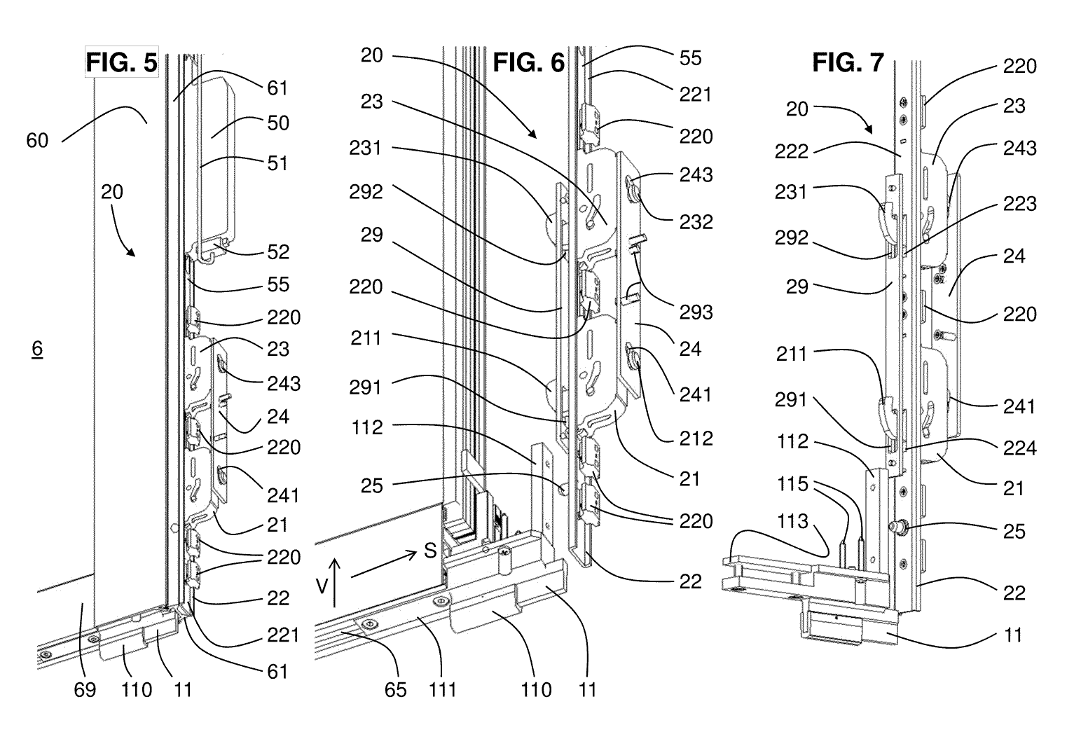

FIG. 5 illustrates the second sliding wing 6 with the closing device 20. The vertical profile 60 with the ridge 61 is apparent, and it can be seen that the ridge 61 extends from the bottom all the way upward. The lock plate 22 is illustrated in a position in which said lock plate comes to lie when the vertical profiles 40, 60 intermesh, i.e. when the vertical closing edges 4a, 6a are in contact with each other in the closed position.

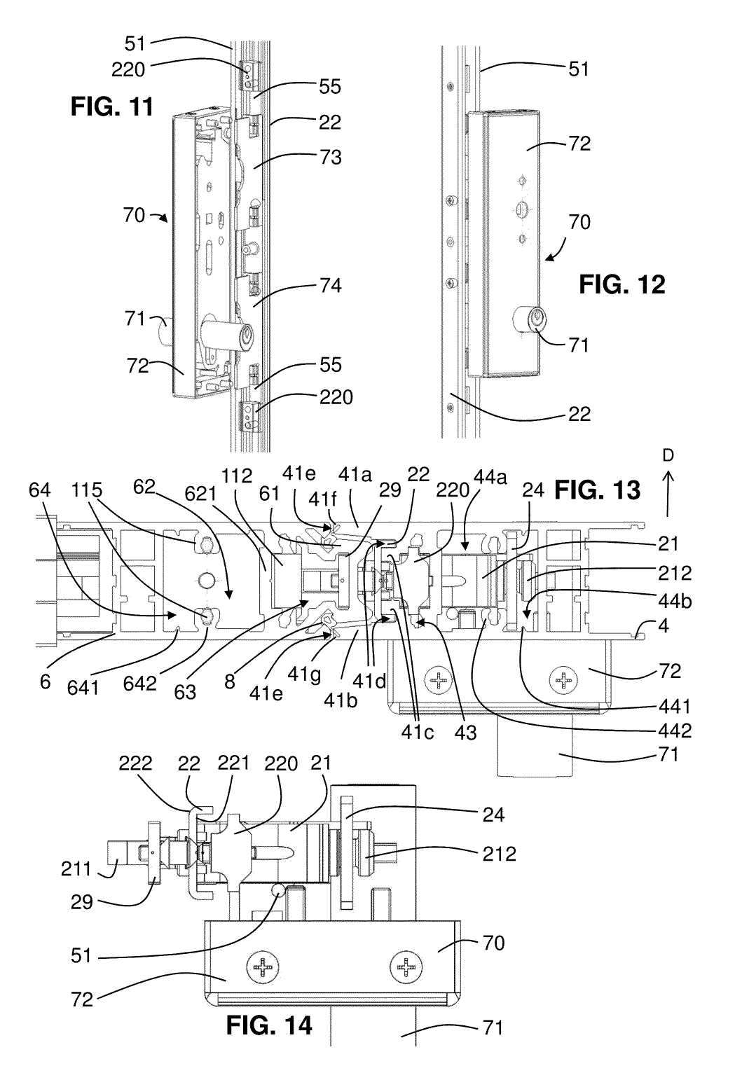

The U lock plate 22 is accommodated in the vertical profile 40 which is not illustrated in FIG. 5. Pivoting bolt cases 21, 23, 26, 27, sliding blocks 220 and the motor 50 are attached on an inner side 221 of the lock plate 22 (also see below and FIG. 10). The elements just mentioned are therefore accommodated in the vertical profile 40. The pivoting bolt cases 21, 23, 26, 27 are known, for example, from the prior art and surround a pivoting bolt 211, 231, 261, 271 which is pivotable forward in a pivoting movement, in this case in the direction of the vertical profile 60. The motor 50 is supplied with power and activated via a control and/or feed line 51 which is connected to the motor 50 via a plug 52.

FIG. 6 shows an enlarged detail from FIG. 5, wherein the vertical profile 60 has been omitted for the sake of clarity. The U lock plate 22, on which the sliding blocks 220 and the pivoting bolt cases 21, 23 are visible, can be seen again in FIG. 6. FIG. 7 shows a similar situation, wherein the outer surface 222 of the U lock plate 22 is viewed from the left.

The closing mechanism will now be explained with reference to FIGS. 6 and 7. The pivoting bolt cases 21 and 23 are also referred to here. What is mentioned will then, wherever appropriate, also be applicable to the other pivoting bolt cases 26 and 27. As already described, a pivoting bolt 211, 231 is attached in each pivoting bolt case 21, 23. Said pivoting belt 211, 231 can be guided (by means of a driving rod 55, see below) in a pivoting movement out of the pivoting bolt case 21, 23 through a recess 224, 223 through the U lock plate 22. The extended pivoting bolts 211, 231 protrude over the U lock plate 22 on the outer side 222 thereof and engage in a closing strip 29 arranged in the ridge 61 opposite the lock plate. The bolts 211, 231 here in each case engage behind the closing strip 29 such that a form-fitting connection is realized in a direction parallel to the closing direction S.

For this engagement, engagement recesses 291, 292 are in each case provided in the closing strip 29. One recess 291, 292 is preferably provided per bolt 211, 231. Since the closing strip 29 is attached in a vertical chamber 63 in the ridge 61 (see below), the ridge 61 has apertures at the locations of the recesses 291, 292 of the closing strip 29 such that the bolts 211, 231 can engage in the ridge 61 and in the closing strip 29 located therebehind.

The pivoting bolt 211, 231 is therefore pivoted through the recess 291, 292 to behind the closing strip 29. By means of the hook-like design of the pivoting bolt 211, 231, the pivoting bolt 211, 213 can engage behind the closing strip 29. The closing strip 29 is fixedly attached on or to the second vertical profile 60 (in the ridge 61). The vertical profiles 40, 60 can therefore be fixed in relation to each other by means of the pivoting bolts 211, 231 and the closing strip 29, and therefore an opening movement of the sliding wings 4, 6 (in particular along the closing movement) is prevented.

Furthermore, it can be seen in FIGS. 5-7 that a mushroom-headed pin 212, 232 is attached in each case on the rear sides of the pivoting bolt cases 21, 23, i.e. on that side of the pivoting bolt case 21, 23 which lies opposite the extended pivoting bolt 211, 231. Said mushroom-headed pins 212, 232 in each case protrude (for example up to 20 millimeters) toward the depth of the vertical profile 40. In addition, the holding plate 24 which provides recesses 241, 243 is illustrated in FIGS. 5-7. The mushroom-headed pins 212, 232 and the holding plate 24 then form a bayonet-type closure via said recesses 241, 243 with a form-fitting connection parallel to the direction S. The bayonet-type closure is expedient for efficient installation. The holding plate 24 protrudes over the pivoting bolt cases on the wide side, as does the U lock plate 22, which is apparent from the figures mentioned.

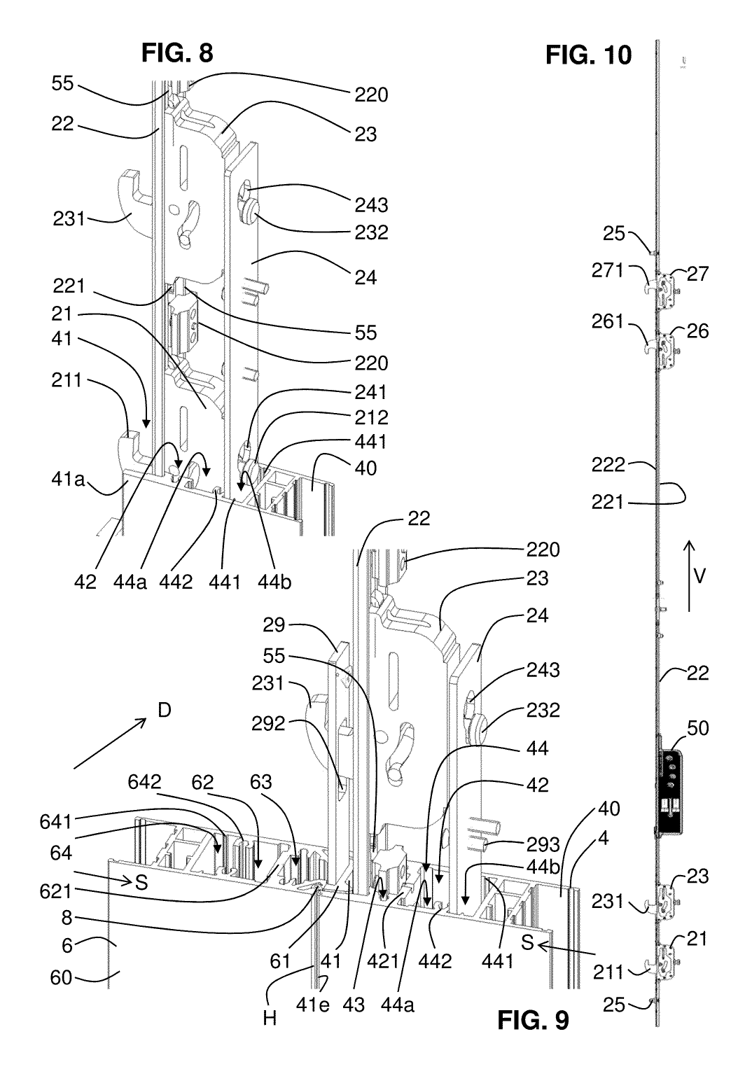

By means of the U lock plate 22, the sliding blocks 220 and the holding plate 24, the pivoting bolt cases 21, 23 are fixed in the vertical profile 40 at the rear and front in a form-fitting manner with respect to a direction parallel to the closing direction S, which will now be described with reference to the following FIGS. 8 and 9. FIG. 8 shows the U lock plate 22 with the pivoting bolt cases 21, 23 which protrude from the U lock plate 22 on the inner side 221 rearward into the depth of the chambers 44a, 44b. The holding plate 24 is also illustrated. In addition, the vertical profile 40 is apparent in the lower region of FIG. 8. It can be seen that the U lock plate 22 can be pushed into the profile 40. The holding strip 24 can be pushed vertically into the profile 40. The vertical profile 40 in each case have corresponding recesses in the vertical chamber 42 (for example in the partition 421, see below). The vertical profile 40 therefore has the vertical chamber 42 for receiving the elements mentioned. Said vertical chamber 42 adjoins the inner side 221 of the U lock plate 22 on the right in FIG. 8, wherein the groove 41 extends to the left from the other side, the outer side 222 of the U lock plate 22. It can be seen here that the groove 41 is bounded by an outer flank 41a and an inner flank 41b and the outer side of the U lock plate. The expression “outer” or “inner” relates here to the respective arrangement of the flank 41a, 41b with respect to the outer side or the inner side of the building opening which is closable by the system 1.

The outer flank 41a and the inner flank 41b can be seen in FIG. 13. Said flanks 41a and 41b have free ends 41f and 41g, respectively. At the free ends 41f, 41g, the flanks 41a, 41b have a thickness of 4 millimeters (in the pass-through direction D), wherein said thickness or material thickness increases rearward (i.e. toward the lock plate 22) by 25% to 30%. The corresponding edges can be rounded in each case.

When the two vertical closing edges 4a, 6a are in close contact with the ridge 61, the flanks 41a, 41b engage over each other in such a manner that unauthorized access via the main closing edge H (i.e. the vertical closing edges 4a, 6a) to parts of the closing device 20 (for example by means of a lever tool, such as a crowbar) is made more difficult, which has a burglary-resistant effect. A vertically running gap 41e (see FIG. 3) which is present between the free ends 41f, 41g of the flanks 41a, 41b and the vertical profile 60 in the closing direction S (see FIG. 13) is therefore intended to be minimal, and here (in the case of vertical profiles with a thickness of 35 millimeters in the D direction), the gap then has a width of less than 1 millimeter. It is basically desirable not to provide said gap 41e to be wider, and therefore a customary tool cannot be fitted. In addition, the flanks 41a, 41b (and also the ridge 61) are intended to be formed to be stable and thick enough in order to withstand a forcible intrusion attempt for as long as possible.

It can be seen in FIG. 13 that the ridge 61 is preferably formed on the vertical profile 60 in such a manner that the flanks 41a, 41b engage to the sides of the ridge 61 (i.e. in the D direction) in the vertical profile 60 such that an aligned surface 46 (see FIG. 3) is formed toward the outer side (and preferably also the inner side). This further minimizes the number of possible attack points for a lever tool or impact tool. The groove 41 is bounded by the outer side 222 of the lock plate 22 at the depth of 11.5 millimeters. The chamber 42 adjoins the groove 41 on the inner side 221, which is opposite the outer side 222, of the U lock plate 22, which has a thickness of 1 to 3 millimeters, and extends both in the vertical direction V and also by 20 to 100 millimeters into the depth, i.e. counter to the closing direction S of the closing wing 4, in the vertical profile 40.

FIG. 9 illustrates the two vertical profiles 40 and 60. It can be seen that vertical profile 60 also has a vertical chamber 62. As can furthermore be seen in FIG. 9, a partition 621 which runs in the vertical direction divides the vertical chamber 62 into two vertical partial chambers 63 and 64 (this partition 621 corresponds to the partition 421 in the first vertical profile 40, see below). The first partial chamber 63 extends here from the rear into the ridge 61. The second partial chamber 64 is located deeper (i.e. further to the rear, counter to the closing direction S) in the vertical profile 60 than the first partial chamber 63 and has vertical webs 642 which are attached laterally centrally with respect to the closing direction and extend from the edge into the chamber 62. The first and second partial chambers 63, 64 run all the way downward in the vertical profile 60 and are open downward. As has been described above, the floor bolt 11 is introduced into the vertical profile 60 from below. The vertically standing second limb 112 is introduced here into the first partial chamber 63 and bears at the rear against the partition 621. This can also be seen in FIG. 13.

FIG. 13 shows a top view of intermeshing vertical profiles 40, 60 with elements of the closing device 20 and elements of the floor bolt 11. It can be seen that the vertically standing second limb 112 has been pushed into the chamber 63 in a manner guided close to the partition 621.

It is apparent in FIG. 13 that the screws 115 of the floor bolt 11 are screwed into the vertical web 652. For this purpose, the vertical web 642 has a corresponding recess. It is also apparent that the sliding block 220 has been pushed in the profile 40 into the partial chamber 43 which corresponds to the partial chamber 63. Partial chambers 63, 64 are therefore formed substantially mirror-symmetrically with respect to the main closing edge H.

It can furthermore be seen in FIG. 9 that the closing strip 29 is likewise introduced into the partial chamber 63. The closing strip 29 here is pushed into the front region of the partial chamber 63 and makes contact with the ridge 61 from the rear (also see FIG. 13).

So that the pivoting bolts 211, 231 can engage in the recesses 291, 292 of the closing strip 29, the ridge 61 at the appropriate points has pass-through openings from the outside through the recesses 291, 292 into the partial chamber 63.

It is apparent in FIGS. 9 and 13 that a sealing profile 8 is provided in each case in the vicinity of the end regions of the flanks 41a, 41b of the groove 41, which flanks laterally surround the elevation 61. Said sealing profile 8 is attached to that end of the ridge which is on the vertical profile side and makes contact with the free ends of the flanks 41a, 41b in a sealing manner when the sliding wings 40, 60 are closed. It can furthermore be seen in FIGS. 9 and 13 that the closing strip 29 is introduced into the frontmost section of the partial chamber 63, wherein said frontmost part of the partial chamber 63 surrounds the closing strip 29 to the rear such that the closing strip 29 is fixed in a form-fitting manner in the closing direction S.

The vertical profile 40 is illustrated on the right side in FIG. 9. The vertical chamber 42 which is divided by a partition 421 into two vertical chambers 43 and 44a, 44b is seen. The vertical partial chamber 44a, 44b has a second vertical web 442 centrally with respect to the closing direction S, and a first vertical web 441 behind the second vertical web 442. The second vertical profile 60 has a corresponding vertical web 641. The vertical web 441, 442, 641, 642 run parallel to the groove 41 and to the ridge 61. The holding strip 24 is pushed into the vertical partial chamber 44a, 44b, specifically between the first vertical web 441 and the second vertical web 442, and is therefore fixed in a form-fitting manner in a direction parallel to the closing direction S. The holding strip 24 spans the vertical profile 40 over the entire clear width (in direction D) and thus divides the partial chamber 44a, 44b into a front partial chamber 44a and a rear partial chamber 44b (also see FIG. 13).

For the vertical securing of the holding strip 24, screws 293 running substantially horizontally pass through the holding strip 24 from the front to the rear, wherein the screws 293 protrude to the rear via the holding strip 24. A back wall of the vertical partial chamber 44b can then have threaded holes (or can provide corresponding means) in which the holding strip 24 is secured by means of screws 293. The holding strip 24 can also be secured vertically in another manner obvious to a person skilled in the art. It is also possible for a plurality of holding strips 24 (and/or closing strips 29) to be provided in the vertical profiles 40 (or in the profile 60), depending on the number of pivoting bolt cases.

Furthermore, it can be seen in FIGS. 8, 9 and 13 that the mushroom-headed pins 212, 232 are guided through the openings 243 in the holding strip 24 and, pushed downward, form a bayonet-type closure. By means of the mushroom-shaped expansion of the pin 212, 232 toward the rear, the pivoting bolt case 21, 23 is then secured in the depth of the vertical chamber 42 via the holding strip 24 in a form-fitting manner with respect to a direction parallel to the closing direction S.

FIG. 13 shows that the U lock plate 22 which is introduced from the front into the groove 41 and limits the depth of the groove 41 to the rear, and the sliding blocks 220, which are introduced into the partial chamber 43 in a form-fitting manner and are vertically movable, interact bringing about a form-fitting connection. The sliding blocks 220 are secured by screws which run from an outer side 222 through the U lock plate 22 into the sliding blocks 220. The sliding blocks 220 are inserted in the vertical partial chamber 43 and rest from the rear in the closing direction S on a vertically running web 41c of the vertical profile 40. The U lock plate 22 rests from the front on said webs 41c. As is shown in FIG. 13, the free ends of the U lock plate 22 protrude rearward into corresponding, outwardly open slots 41d which are provided in a manner running vertically in the webs 41c. If the screw which is guided through the U lock plate 22 into the sliding block 220 is tightened, this fixedly clamps the sliding block 220 and the lock plate 22 on the vertical webs 41c in the slots 41d (see FIG. 13). The U lock plate 22 and a multiplicity of sliding blocks 220 (for example thereof attached in a manner distributed over the length of the lock plate, in particular in the vicinity of the pivoting bolt cases) are fixed in a form-fitting manner in the vertical profile 40. The U lock plate 22 therefore holds the two flanks 41a, 41b together in a form-fitting manner with respect to the pass-through direction D, in other words, the U lock plate 22 engages around the two vertical webs 41c. This increases the stability of the flanks 41a, 41b and counters the flanks being bent upward or broken open from the outside (with respect to the groove 41). It is therefore also preferred that the lock plate extends over the entire length of the groove 41 and ensures the engagement of groove 41 and ridge 61. A form-fitting connection is realized here in a direction parallel to the closing direction S. It can therefore be seen in FIG. 13 that the pivoting bolt case 21, 23 are secured in a form-fitting manner in the vertical profile 40 both in the front region, via the interplay of U lock plate 22, sliding blocks 220 and webs 41c, and in the rear region via the interplay of mushroom-headed pins 212, 232 and holding plate 24. This increases the degree of securing of the closing device 20 in the profile 40.

FIG. 10 shows the U lock plate 22 with four mounted pivoting bolt cases 21, 23, 26, 27 (an upper pair 26, and a lower pair 21, 23). It is also seen that locking pins 25 are attached on the outer side 222 of the U lock plate 22. One such locking pin 25 can also be seen in the lower part of FIG. 7. When the doors 4, 6 are closed, said pins 25 (also called centering pins 25) engage in a corresponding recess, which is preferably reinforced by a closing part, on the vertical closing edge 6b of the second vertical profile (here in the ridge 61), as a result of which the guiding of the sliding wings 4, 6 is improved and the stability of the system in the closed state is increased as a whole. Furthermore, it can be seen in FIG. 10 that the pivoting bolt cases 21, 23 are arranged in such a manner that the lower pivoting bolts 211, 231 of the lower pivoting bolt cases 21, 23 are guided in a pivoting movement which leads from the bottom upward. The upper pivoting bolt cases 26, 27 are arranged the other way around (i.e. in an opposed manner), and therefore the pivoting bolts 261, 271 thereof execute a pivoting movement which points from the top downward. By means of this mirror-symmetrical arrangement, it is prevented that the locked sliding wings 4, 6 can be moved upward or downward and hence the pivoting bolts 211, 231, 261, 271 can simply be lifted out of the corresponding recesses of the closing strip 29. In order to achieve this, it can also be provided that the upper pair of pivoting bolts 261, 271 pivots from the bottom upward and the lower pair of pivoting bolts 211, 231 pivots in an opposed manner from the top downward. Alternatively, it is conceivable that the pivotable bolts 211, 231 or 261, 271 of a pair of pivoting bolts 211, 231 or 261, 271 are pivotable in an opposed manner.

In order to actuate the respective pivoting bolt cases 21, 23, 26, 27, the driving rod 55, which can be seen in FIGS. 5, 6, 8, 9, runs on the inner side 221 of the U lock plate 22. Said driving rod 55 is movable linearly, wherein the linear movement thereof is transformed in the pivoting bolt cases 21, 23, 26, 27 in such a manner that the pivoting bolts 211, 231, 261, 271 carry out their corresponding pivoting movements. In order to actuate said driving rod 55, the motor 50 can be provided (see, for example, FIG. 5) or else the driving rod 55 can be actuated manually. Instead of the motor, it is also possible to use, for example, a solenoid or other electrically operated elements for actuating the driving rod 55. Either an embodiment for automatic actuation or an embodiment for manual actuation is therefore possible.

FIG. 11 illustrates a central lock 70 which serves as the main lock 70. Said main lock 70 has a lock cylinder 71 in which, for example, a key can be introduced. If the key fits, then, by corresponding rotational movement of the key via a known closing mechanism, the driving rod 55 can either be actuated manually or automatically via the motor 50. In order to make unauthorized access from the outside to the driving rod 55 and to the main lock 70 even more difficult, bore protection plates 73, 74 are attached in a protective manner, as apparent in FIG. 11. Said bore protection plates 73, 74 block access to the driving rod 55 and are preferably made of steel and have a thickness of several millimeters.

FIG. 12 shows the central lock 70 again in a view from the front and the relative arrangement thereof to the U lock plate 22. Part of the lock cylinder 71 and the cover 72 can be seen from the front.

FIG. 14 shows the subject matter of FIG. 12 in a view from below. The central lock 70 with the lock cylinder 71 and the cover 72 and also the U lock plate 22 with fitted pivoting bolt case 21 and mushroom-headed pin 212, which adjoins to the right and engages through a corresponding recess in the holding strip 24 and passes through the latter, are shown.

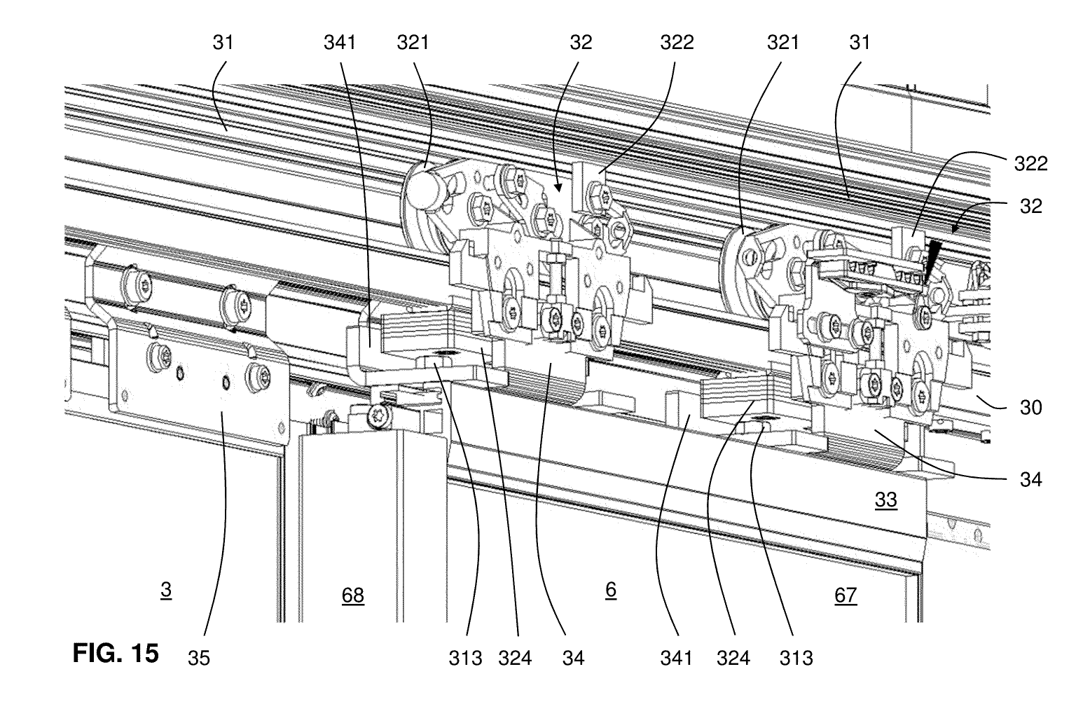

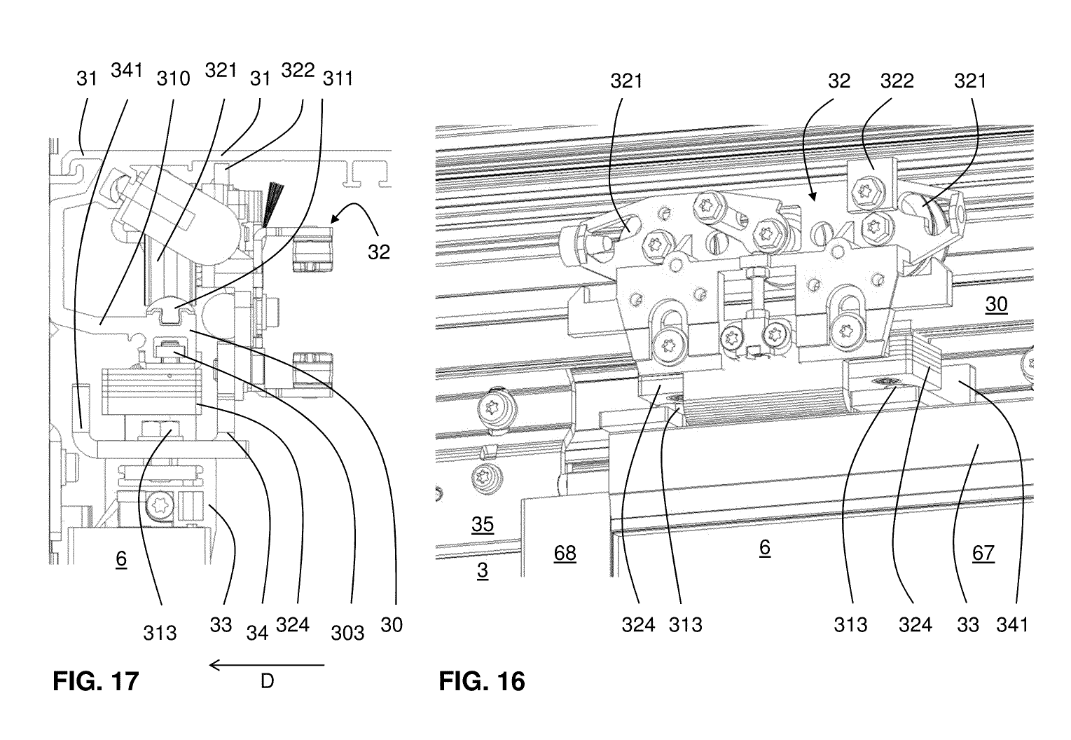

FIG. 15 shows, in a perspective side view from the bottom at the front on the left, the second sliding wing 6 with the vertical terminating profile 68 and the door filling 67. FIG. 16 shows an enlarged detail of the illustration according to FIG. 15 from a more frontal perspective. FIG. 17 which shows the subject matter according to FIG. 15 from the side is also noted in this respect. The hatching of the section has been omitted in each case in FIG. 17 for the sake of clarity.

It can be seen in FIGS. 15, 16 that an upper horizontal profile 33 is provided in the upper end region of the sliding wing 6, which horizontal profile extends between the second vertical profile 60 and the vertical terminating profile 68 (parallel to the lower horizontal profile 69 at the upper end of the door filling). The door leaf 6 of the sliding wing 6, which is upwardly adjoined by the upper horizontal profile 33, can also be seen at the bottom in FIG. 17. The upper horizontal profile 33 is fixedly connected to the respective sliding wing 6. The horizontal profiles 33, 69, the second vertical profile 60 and the vertical terminating profile 68 therefore form an encircling frame in which the door filling 67 of the wing 6 is provided. It goes without saying that the details described here can also be relevant to the first sliding wing 4 which (except, for example, for the mirror-inverted configuration) can structurally differ, depending on the embodiment, from the second sliding wing 6, for example, essentially only in the region of the vertical profile 40.

The sliding wing 6 is fastened to two running carriages 32 above the upper horizontal profile 33 which extends substantially horizontally between the vertical terminating profile 68 and the second vertical profile 60. For this purpose, a secure screw connection-screws 313 is preferred.

For the suspension of the sliding doors 4, 6, a stationarily secured running profile 31 is provided with a rail profile 30 (see in particular FIGS. 15, 17) which provides means for the suspension and guidance of the running carriages 32. As can readily be seen in FIG. 17, the running profile 31 provides a limb 310 running horizontally along the closing movement of the sliding wing 6. The limb 310 has a free-standing end, on the upper side of which a rail 311 for the running carriage 32 is provided. The running carriages 32 have running wheels 321 which provide a concave running surface. When the running carriage 32 is placed onto the rail 311, said rail, in accordance with its convex cross-sectional design, engages in the concave running surfaces of the running wheels 321. Here, 2 or 3 such running wheels 321 are provided per running carriage 32. In addition, it goes without saying that the rail 311 can also be formed concavely and the respective running surface of the running wheel 321 can be formed convexly, which permits a similar engagement acting in a laterally guiding manner. On account of this configuration, the sliding wing 6 can be pivoted over a limited angular range perpendicular to the closing movement without the forces which are in effect in the process causing damage to rail 311, rail profile 30 and/or running wheels 321.

If the sliding wing 6 in the view according to FIG. 17 is then lifted upward, there is basically the risk of the sliding wing 6 being disengaged from the running profile 31.

In order to limit the freedom of movement upward to a region which does not permit such a disengagement, a first anti-prying-open means 322 is provided in the form of a metal plate 322 which protrudes upward from the running carriage body of the running carriage 32 and limits the abovementioned lifting-out movement of the wing 6 upward (see FIG. 17) by the plate 322 being present at the top on the running profile 31 in a manner forming an extensive contact. The contact surfaces of said contact, which forms the stop, are preferably rough, and therefore a displacement of the raised sliding wing 6, pressing the plate 322 against the running profile 31, along the closing movement into the open state is made difficult or is not possible. These contact surfaces can also come to a stop in a manner engaging in each other via a corresponding toothing which provides ridges running in the D direction on the two contact surfaces, and therefore an abovementioned displacement of the raised sliding wing is then likewise prevented. Said plate 322 can be offset in the vertical direction with respect to a pivot point (defined by the rail 311) (see FIG. 17, the plate 322 is offset to the right). However, it is also conceivable for the plate 322 to be attached in a different manner (and therefore to make contact with a different, preferably stationary element); it is important that the plate 322 limits the lifting-out movement of the running carriage 32 (to the right and upward in FIG. 17) and of the wing 6. Each running carriage 32 here can provide at least one stop 322.

The running carriages 32 make contact with the running profile 31 in a manner rolling over the rail 311 which is provided on a limb 310 of the running profile 31, said limb protruding horizontally from the running profile 31 and running parallel to the closing direction S. The running carriage 32 then at least partially extends upward with the running carriage body in front of the limb 310 (as described above) and also to under the limb 310 via a wing adaption bracket 34 (see FIGS. 15-17).

As can be seen in FIGS. 15-17, a plate-like second anti-prying-open means 324 is attached at the bottom to the limb 310, in each case in the region above the adaption bracket 34 of each running carriage 32, in the closed position. It is shown in FIG. 17 that the screw connection 303 is provided for this purpose. The second anti-prying-open means 324 extends downward under the rail 311 and provides a stop for the respective adaption bracket 34, which limits a pivoting of the sliding wing 6 to both sides in the pass-through direction D (to the left and right in FIG. 17). The second anti-prying-open means 324 is composed here (as indicated in FIG. 17) of a plurality of plates, preferably made from metal or plastic. Said plates can each have a thickness of, for example, 3 to 15 millimeters. As a result, the excess length of the anti-prying-open means 324 downward can be adapted via the limb 310. The distance between fixing screws 313 and adaption bracket 34 and second anti-prying-open means 324 can therefore be adapted.

The substantially U-shaped adaption bracket 34 engages here downward around the second anti-prying-open means 324 and is guided upward again behind the second anti-prying-open means 324 (on the left in FIG. 17) via a section 341. Looking at FIG. 17, it is clear that, if the wing 6 is pivoted to the right, the section 324 of the adaption bracket 34 strikes on the left against the second anti-prying-open means 324. In the event of a pivoting movement of the wing 6 to the left, the adaption bracket 34 strikes in the right region of the second anti-prying-open means 324 (according to FIG. 17) and/or the section 341 strikes on the left against the profile 30 (or an associated screw). It is also conceivable that the fixing screws 313 limit said pivoting movements to the left and to the right or support or ensure the limiting effect. The fixing screws 313 likewise strike against the second anti-prying-open means 324 when the wing 6 is raised upward and thereby support the effect of the abovementioned first anti-prying-open means 322. It is conceivable that an alternative geometry according to another type obvious to a person skilled in the art is selected.

By means of the above-described blocking of lifting and/or pivoting movements of the wing 6 (and in the same manner also of the wing 4), it is prevented that the floor bolts 11, 13 are levered out of the guide chamber 151, which increases the security against intrusion and stability of the system 1.

By means of the first and second anti-prying-open means 322, 324, prying open of the sliding wing, in particular in interplay with the above-described floor bolts which are guided along the closing movement in the floor guide 150, 160, is effectively made difficult.

In addition, the accessibility to screws or other elements in the region of the running profile 31 is additionally made difficult by the adaption bracket with the section 341 drawn upward to the rear, which further increases the security of the device against intrusion.

It can furthermore be seen in FIG. 15 that the side part 3 illustrated on the left in the lower region is fastened to the running profile 31 via a stable fastening plate 35, preferably made of metal and with a thickness of up to 1 centimeter, preferably by a multiplicity of screws.

### LIST OF DESIGNATIONS

1 Sliding wing system
2, 3 Side part
5 Upper light
11 First floor bolt
13 Second floor bolt
110, 130 Sliding element
111, 131 First limb
112, 132 Second limb
113, 133 Plate
114, 134 Screws
115 Screws
116 Projection
118, 138 Engagement element
150 Floor guide profile
151 Guide chamber
152 Guide chamber wall
153 Support surface
160 Floor connecting profile
161 Support element
20 Closing device
21, 23, 26, 27 Pivoting bolt case
211, 231, 261, 271 Pivoting bolt
212, 232 Mushroom-headed pin
22 U lock plate
221 Inner side
222 Outer side
223, 224 Recess
220 Sliding block
24 Bayonet-type strip/holding strip
241, 243 Recess
25 Locking pin
29 Closing strip
291, 292 Engagement recess
293 Screw
30 Rail profile
303 Screw connection
31 Running profile
311 Running rail
313 Fixing screw
32 Running carriage
321 Running wheel
322 First anti-prying-open means
324 Second anti-prying-open means
33 Upper horizontal profile
34 Wing adaption bracket
341 Section
35 Fastening plate
4 First sliding wing
4a First vertical closing edge
4b First horizontal closing edge
40 First vertical profile
41 Groove
41a, 41b Flank
41c Vertical web
41d Slot
41e Gap
41f, 41g Free end of the flank
42 Vertical chamber
421 Partition
43 First partial chamber
44 Second partial chamber
44a, 44b Partial chambers of the chamber 44
441 First vertical web
442 Second vertical web
46 Aligned surface
50 Motor
51 Control line
52 Plug
55 Driving rod
6 Second sliding wing
6a Second vertical closing edge
6b Second horizontal closing edge
60 Second vertical profile
61 Ridge
62 Chamber
621 Partition
63 First partial chamber
64 Second partial chamber
641, 642 Vertical web
65 Recess
66 Vertical chamber
67 Door filling
68 Vertical terminating profile
69 Horizontal profile
70 Main lock
71 Lock cylinder
72 Cover
73, 74 Bore protection plate
8 Sealing profile
D Pass-through direction
H Main closing edge
N1 First secondary closing edge
N2 Second secondary closing edge
S Closing direction
V Vertical direction
V1 First vertical secondary closing edge
V2 Second vertical secondary closing edge

1. A sliding wing system, comprising at least one sliding wing,
wherein the sliding wing is displaceable in a floor guide device along a closing movement so as to close a building opening in a pass-through direction and provides a first vertical closing edge in a substantially horizontal closing direction, and
the sliding wing system provides a second vertical closing edge,
wherein the first and the second vertical closing edge can be brought into closing contact with each other, and
wherein the sliding wing provides a horizontal closing edge which, together with the floor guide device, forms a horizontal secondary closing edge extending along the closing direction,
wherein at least one dimensionally stable outer flank which extends substantially in the vertical direction, protrudes freely in the closing direction and is composed of metal or plastic or a combination thereof is provided at least in sections on at least one of the vertical closing edges,
wherein the outer flank is attached on the corresponding vertical closing edge in a manner offset toward an outer side of the building opening and forms a step,
wherein a dimensionally stable ridge which corresponds to said outer flank, extends substantially in the vertical direction and protrudes in the closing direction and is composed of metal or plastic or a combination thereof is arranged on the other vertical closing edge, in each case opposite said outer flank,
wherein said ridge runs with respect to the outer flank in a manner offset laterally toward an inner side of the building opening and, by means of the closing movement, can be brought into bearing engagement against an inner side of the flank, which inner side is directed toward the inner side of the building opening, along with the abovementioned step, substantially over the depth thereof, and
in that wherein a closing device which is arranged on said vertical closing edges and has at least one locking point for fixing the sliding wing when the first and second vertical closing edges are in closing contact with each other is provided,
wherein said locking point is provided on the ridge side, and therefore the outer flank covers the locking point toward the outer side of the building opening.

2. The sliding wing system (1) as claimed in claim 1,
wherein a further, inner flank which runs substantially parallel to the outer flank and is attached in a manner offset at a distance in the pass-through direction from the outer flank toward the inner side of the building opening is provided on the vertical closing edge providing the outer flank,
wherein a vertically running groove is formed between the outer flank and the inner flank in such a manner that said groove and said ridge can be brought into engagement with each other by the closing movement, and
wherein said engagement, taken together in sections, extends over at least half of the longitudinal extent of the vertical closing edges.

3. The sliding wing system as claimed in claim 1, wherein the flank protrudes over the vertical closing edge in the closing direction freely by 10 millimeters to 30 millimeters and has a material thickness in the pass-through direction, said material thickness being at least 2 millimeters to 10 millimeters.

4. The sliding wing system as claimed in claim 1, wherein the ridge is attached to the corresponding vertical closing edge in a manner offset toward the inner side of the building opening, and therefore, when the vertical closing edges are in closing contact, the outer flank which is provided so as to be able to cover the ridge toward the outer side of the building opening engages over the ridge in the closing direction to such an extent toward the vertical closing edge providing the ridge that a vertical gap between the free end of the outer flank and the vertical closing edge providing the ridge is less than 2 millimeters.

5. The sliding wing system as claimed in claim 2, wherein the flanks are flanks which are spaced apart with respect to each other in the pass-through direction.

6. The sliding wing system as claimed in claim 2,
wherein the closing device provides at least one engagement recess, which is continuously open in the closing direction toward the outside, on one of said vertical closing edges, and
wherein the closing device has at least one bolt which is attached to the other vertical closing edge and which, when the vertical closing edges bear against each other in a closing manner for locking the sliding wing, is rotatable, pivotable and/or displaceable into said engagement recess for the form-fitting engagement with respect to a direction parallel to the closing direction, and
wherein said engagement recess and the corresponding bolt form a locking point.

7. The sliding wing system as claimed in claim 6, wherein the vertical closing edges provide at least two locking points which are spaced apart vertically and form a pair.

8. The sliding wing system as claimed in claim 1,
wherein the closing device provides at least one closing strip which is attached in the ridge and which at least partially surrounds the engagement recess, and
wherein the closing device provides at least one pivoting bolt case, which is attached in the depth of the groove, with a pivoting bolt which is mounted along a pivoting movement and, when the vertical closing edges bear against each other, so as to be pivotable from the pivoting bolt case into the respective engagement recess into a locking position.

9. The sliding wing system as claimed in claim 1,
wherein at least one floor bolt with an engagement element is provided on the horizontal secondary closing edge of the at least one displaceable sliding wing,
wherein the floor guide device provides, along the closing movement, a floor guide profile with a guide chamber which is open upward, is bounded in the pass-through direction by a guide chamber wall and corresponds with the floor bolt,
wherein the engagement element of the floor bolt is movable displaceably along the closing movement in a manner projecting substantially over its protrusion height in the guide chamber and guiding the displaceable sliding wing, and
wherein the floor bolt makes contact with the guide chamber wall preferably via a sliding element.

10. The sliding wing system as claimed in claim 1, wherein the sliding wing system comprises at least one first sliding wing and one second, opposed sliding wing for closing the building opening, which sliding wings are displaceable in the floor guide device along the closing movement and parallel to the closing direction in a manner releasing or closing the building opening, wherein the first sliding wing in the closing direction provides the first vertical closing edge and the second sliding wing in the closing direction provides the second vertical closing edge.

11. The sliding wing system as claimed in claim 1,
wherein the first vertical closing edge is provided by a first vertical profile and the second vertical closing edge is provided by a second vertical profile, and,
wherein one of the first and second vertical profiles provides the at least one groove, and the other vertical profile provides the ridge which corresponds with said groove.

12. The sliding wing system as claimed in claim 1, wherein the groove is configured, as seen in a cross section from the vertical direction, so as to be substantially rectangular or trapezoidal at least in sections and so as to widen in the closing direction.

13. The sliding wing system as claimed in claim 7,
wherein the first and the second vertical profile intermesh forming a the substantially aligned surface along the first and second closing edges and parallel to the closing direction.

14. The sliding wing system as claimed in claim 10,
wherein the at least one displaceable sliding wing provides a vertical terminating profile on its end section opposite the vertical closing edge, wherein the horizontal closing edge is in each case formed by lower ends of the vertical profile and of the vertical terminating profile,
wherein one of said floor bolts is provided in each case on the horizontal closing edge, on the end side in a direction parallel to the closing direction, or
wherein the floor bolts are each substantially L-shaped and each have a first limb protruding by 40 millimeters to 200 millimeters horizontally from the engagement element, and
wherein the floor bolts are in each case fastened by the first limb to the horizontal closing edge, and wherein the respective vertical profile and the vertical terminating profile of a sliding wing at their lower ends in each case provide vertical chambers which are open downward and run in the vertical direction and into which the second limb can in each case be completely pushed and can be fixed there.

15. The sliding wing system as claimed in claim 1, wherein a lock plate which extends in the vertical direction, is fixed in a form-fitting manner at least with respect to a direction parallel to the closing direction, wherein a vertical chamber extending rearward into the sliding wing is provided on an inner side of said lock plate, said inner side facing away from the vertical closing edge, and wherein the at least one pivoting bolt case with a pivoting bolt is fastened so as to project from said inner side of the lock plate into a depth of the vertical chamber counter to the closing direction, wherein the pivoting bolt is pivotable in a pivoting movement out of the pivoting bolt case through a recess in the lock plate into the groove and, when the vertical closing edges are in closing contact, into the engagement recess.

16. The sliding wing system as claimed in claim 15, wherein the pivoting bolt case is fastened at the rear in the depth of the vertical chamber by means of a further form-fitting connection with respect to a direction parallel to the closing direction, via at least one mushroom-headed pin which is attached to the pivoting bolt case and protrudes rearward into the depth of the vertical chamber and which is fixable in a form-fitting manner in recesses in a holding strip which is attached in a form-fitting manner with respect to the direction parallel to the closing direction in the depth of the vertical chamber.

17. (canceled)

18. The sliding wing system as claimed in claim 16, wherein at least two pairs of pivoting bolt cases are provided, wherein a lower pair of pivoting bolt cases is attached below the central lock and/or the motor, and an upper pair of pivoting bolt cases is attached above the central lock or the motor, wherein the pivoting bolts are provided.

19. The sliding wing system as claimed in claim 1, wherein an anti-prying-open means which is provided above the at least one sliding wing is included, which anti-prying-open means, at least when the building opening is closed, is limited raising of said sliding wing in the vertical direction and/or pivoting of said sliding wing in the pass-through direction.

20. A closing edge construction for a sliding wing system as claimed in claim 1, wherein the groove is formed by flanks which are attached to one of the vertical closing edges, and are spaced apart from one another in the pass-through direction.

21. The sliding wing system as claimed in claim 1, wherein a further, inner flank which runs substantially parallel to the outer flank and is attached in a manner offset at a distance in the pass-through direction from the outer flank toward the inner side of the building opening is provided on the vertical closing edge providing the outer flank, wherein said inner flank protrudes by substantially the same amount in the closing direction as the outer flank, wherein a vertically running groove is formed between the outer flank and the inner flank in such a manner that said groove and said ridge can be brought into engagement with each other by the closing movement, wherein said engagement, taken together in sections, extends over at least half of the longitudinal extent of the vertical closing edges, and wherein said ridge extends in the pass-through direction substantially over the clear width of the groove and in the vertical direction substantially over a length of the groove and, upon engagement in the groove, engages substantially as far as to a depth of the groove.

22. The sliding wing system as claimed in claim 21, wherein the flank protrudes over the vertical closing edge in the closing direction freely by 10 millimeters to 30 millimeters and has a material thickness in the pass-through direction, said material thickness tapering toward a free end of the flank and in each case being at least 2 millimeters to 10 millimeters.

23. The sliding wing system as claimed in claim 1, wherein the ridge is attached to the corresponding vertical closing edge in a manner offset toward the inner side of the building opening, and therefore, when the vertical closing edges are in closing contact, the outer flank which is provided so as to be able to cover the ridge toward the outer side of the building opening engages over the ridge in the closing direction to such an extent toward the vertical closing edge providing the ridge that a vertical gap between the free end of the outer flank and the vertical closing edge providing the ridge is less than 1 millimeter, and wherein in a region about said vertical gap a substantially aligned surface is formed toward the outer side of the building opening.

24. The sliding wing system as claimed in claim 2, wherein the flanks are flanks which are spaced apart with respect to each other in the pass-through direction by at least 10 millimeters or more, and run substantially continuously along the vertical closing edge, wherein said flanks are attached to end regions, which lie opposite each other in the pass-through direction, of the corresponding vertical closing edge, and the groove formed by the flanks has a depth in a direction parallel to the closing direction of at least 10 millimeters to 30 millimeters or more and has a clear width in the pass-through direction of at least 10 millimeters or more.

25. The sliding wing system as claimed in claim 1, wherein the closing device provides at least one engagement recess, which is continuously open in the closing direction toward the outside, on one of said vertical closing edges, in the ridge or in the depth of the groove, and wherein the closing device has at least one bolt which is attached to the other vertical closing edge and is arranged in the depth of the groove or in the ridge and which, when the vertical closing edges bear against each other in a closing manner for locking the sliding wing, is rotatable, pivotable or displaceable into said engagement recess for the form-fitting engagement with respect to a direction parallel to the closing direction, wherein said engagement recess and the corresponding bolt form a locking point.

26. The sliding wing system as claimed in claim 25, wherein the vertical closing edges provide at least two locking points which are spaced apart vertically and form a pair, wherein a distance between said two locking points is 50 millimeters to 250 millimeters or less, wherein, two or more such pairs of locking points are arranged distributed over the vertical closing edges.

27. The sliding wing system as claimed in claim 6, wherein the closing device provides at least one closing strip which is attached in the ridge and runs vertically and which at least partially or completely, surrounds the engagement recess, and wherein the closing device provides at least one pivoting bolt case, which is attached in the depth of the groove, with a pivoting bolt which is mounted along a pivoting movement and, when the vertical closing edges bear against each other, so as to be pivotable from the pivoting bolt case into the respective engagement recess into a locking position, wherein the pivoting bolt engages behind the closing strip in the locking position, and wherein said pivoting bolt is formed from steel, and the steel has a material thickness of at least 3 to 8 millimeters or more.

28. The sliding wing system as claimed in claim 1, wherein at least one floor bolt with an engagement element is provided on the horizontal secondary closing edge of the at least one displaceable sliding wing, wherein the engagement element protrudes freely downward by 5 millimeters to 50 millimeters from the horizontal secondary closing edge and extends over 50 millimeters to 200 millimeters along the closing direction, wherein the floor guide device provides, along the closing movement, a floor guide profile with a guide chamber which is open upward, is bounded in the pass-through direction by a guide chamber wall and corresponds with the floor bolt, wherein, a floor connecting profile which is embedded in the floor and is intended for receiving the floor guide profile is provided, wherein the engagement element of the floor bolt is movable displaceably along the closing movement in a manner projecting substantially over its protrusion height in the guide chamber and guiding the displaceable sliding wing, wherein the floor bolt makes contact with the guide chamber wall via a sliding element.

29. The sliding wing system as claimed in claim 1,
wherein the sliding wing system comprises at least one first sliding wing and one second, opposed sliding wing for closing the building opening, which sliding wings are displaceable in the floor guide device along the closing movement and parallel to the closing direction in a manner releasing or closing the building opening, and
wherein the first sliding wing in the closing direction provides the first vertical closing edge and the second sliding wing in the closing direction provides the second vertical closing edge.

30. The sliding wing system as claimed in claim 1,
wherein the first vertical closing edge is provided by a first vertical profile and the second vertical closing edge is provided by a second vertical profile,
wherein said vertical profiles are formed from metal or plastic or a combination thereof and extend 40 millimeters to 200 millimeters, in the closing direction and 20 millimeters to 100 millimeters, in the pass-through direction and substantially over an entire height of the opening, and
wherein one of the first and second vertical profiles provides the at least one groove, which extends along the entire vertical closing edge, and the other vertical profile provides the ridge which corresponds with said groove and extends substantially along the whole of the groove.

31. The sliding wing system as claimed in claim 1, wherein the groove is configured, as seen in a cross section from the vertical direction, so as to be substantially rectangular or trapezoidal at least in sections or over the entire depth and so as to widen in the closing direction.

32. The sliding wing system as claimed in claim 10,
wherein the at least one displaceable sliding wing provides a vertical terminating profile on its end section opposite the vertical closing edge,
wherein the horizontal closing edge is in each case formed by lower ends of the vertical profile and of the vertical terminating profile and a horizontal profile connecting said lower ends of the sliding wing,
wherein one of said floor bolts is provided in each case on the horizontal closing edge, on the end side in a direction parallel to the closing direction, or wherein the floor bolts are each substantially L-shaped and each have a first limb protruding by 40 millimeters to 200 millimeters horizontally from the engagement element and in each case a second limb protruding by 40 millimeters to 150 millimeters vertically upward over the engagement element, wherein the floor bolts are in each case fastened by the first limb to the horizontal closing edge, and
wherein the respective vertical profile and the vertical terminating profile of a sliding wing at their lower ends in each case provide vertical chambers which are open downward and run in the vertical direction and into which the second limb can in each case be completely pushed and can be fixed there, wherein said floor bolts are manufactured from steel.

33. The sliding wing system as claimed in claim 7,
wherein a lock plate which extends in the vertical direction, is fixed in a form-fitting manner at least with respect to a direction parallel to the closing direction, and holds together the flanks of the groove limits the groove in depth,
wherein a vertical chamber extending rearward into the sliding wing is provided on an inner side of said lock plate, said inner side facing away from the vertical closing edge, and
wherein the at least one pivoting bolt case with a pivoting bolt is fastened so as to project from said inner side of the lock plate into a depth of the vertical chamber counter to the closing direction, wherein the pivoting bolt is pivotable in a pivoting movement out of the pivoting bolt case through a recess in the lock plate into the groove and, when the vertical closing edges are in closing contact, into the engagement recess and is fixable in said pivoted-out state.

34. The sliding wing system as claimed in claim 15, wherein the pivoting bolt case is fastened at the rear in the depth of the vertical chamber by means of a further form-fitting connection with respect to a direction parallel to the closing direction, via at least one mushroom-headed pin which is attached to the pivoting bolt case and protrudes rearward into the depth of the vertical chamber and which is fixable in a form-fitting manner in recesses in a holding strip which is attached in a form-fitting manner with respect to the direction parallel to the closing direction in the depth of the vertical chamber.

35. The sliding wing system as claimed in claim 16,
wherein at least two pairs of pivoting bolt cases are provided, wherein a lower pair of pivoting bolt cases is attached below the central lock and/or the motor, and an upper pair of pivoting bolt cases is attached above the central lock and/or the motor, and
wherein the pivoting bolts are provided following different pivoting movements in pairs, wherein the pivoting movements are differentiated wherein the pivoting bolt is either pivotable from the bottom upward or from the top downward into the respective recess of the closing strip.

36. The sliding wing system as claimed in claim 9,
wherein an anti-prying-open means which is provided above the at least one sliding wing is included, which anti-prying-open means, at least when the building opening is closed, is limited raising of said sliding wing in the vertical direction and/or pivoting of said sliding wing in the pass-through direction, for the purpose of disengaging a floor bolt, the floor bolt, in each case by the anti-prying-open means striking against an element arranged opposite the anti-prying-open means, and
wherein said opposite element are parts of a running profile or of a running carriage for moving said sliding wing.

37. A closing edge construction for a sliding wing system as claimed in claim 1,
wherein the groove is formed by flanks which are attached to one of the vertical closing edges, are provided by a vertical profile, protrude by 5 millimeters to 20 millimeters in the closing direction and are spaced apart from one another in the pass-through direction and run substantially continuously along the vertical closing edge,
wherein said flanks are attached to end regions of the vertical closing edge, which end regions are opposite each other in the pass-through direction, and
wherein the flanks are each free-standing in the closing direction and the respective material thickness thereof in the pass-through direction is 1 millimeter to 10 millimeters and wherein said material thickness tapers by 10% to 50% in the closing direction.

38. The sliding wing system as claimed in claim 11,
wherein the at least one displaceable sliding wing provides a vertical terminating profile on its end section opposite the vertical closing edge,
wherein the horizontal closing edge is in each case formed by lower ends of the vertical profile and of the vertical terminating profile,
wherein one of said floor bolts is provided in each case on the horizontal closing edge, on the end side in a direction parallel to the closing direction, or wherein the floor bolts are each substantially L-shaped and each have a first limb protruding by 40 millimeters to 200 millimeters horizontally from the engagement element, and
wherein the floor bolts are in each case fastened by the first limb to the horizontal closing edge, and wherein the respective vertical profile and the vertical terminating profile of a sliding wing at their lower ends in each case provide vertical chambers which are open downward and run in the vertical direction and into which the second limb can in each case be completely pushed and can be fixed there.

39. The sliding wing system as claimed in claim 12,
wherein the at least one displaceable sliding wing provides a vertical terminating profile on its end section opposite the vertical closing edge,
wherein the horizontal closing edge is in each case formed by lower ends of the vertical profile and of the vertical terminating profile,
wherein one of said floor bolts is provided in each case on the horizontal closing edge, on the end side in a direction parallel to the closing direction, or wherein the floor bolts are each substantially L-shaped and each have a first limb protruding by 40 millimeters to 200 millimeters horizontally from the engagement element, and
wherein the floor bolts are in each case fastened by the first limb to the horizontal closing edge, and wherein the respective vertical profile and the vertical terminating profile of a sliding wing at their lower ends in each case provide vertical chambers which are open downward and run in the vertical direction and into which the second limb can in each case be completely pushed and can be fixed there.
